(19) United States
(12) Patent Application Publication
(10) Pub. No.: US 2016/0205148 A1
(43) Pub. Date: Jul. 14, 2016

(54) METHOD AND DEVICE FOR PERFORMING AUDIO/VIDEO STREAMING IN WIRELESS COMMUNICATION SYSTEM

(71) Applicant: LG ELECTRONICS INC., Seoul (KR)

(72) Inventors: Jaeho LEE, Seoul (KR); Minsoo LEE, Seoul (KR); Jangwoong PARK, Seoul (KR); Soyoung KIM, Seoul (KR); Hyeonjae LEE, Seoul (KR); Seungryul YANG, Seoul (KR); Jinpil KIM, Seoul (KR)

(73) Assignee: LG ELECTRONICS INC., Seoul (KR)

(21) Appl. No.: 14/916,072

(22) PCT Filed: Sep. 4, 2014
(86) PCT No.: PCT/KR2014/008294

§ 371 Date: Mar. 2, 2016

Related U.S. Application Data
(60) Provisional application No. 61/873,846, filed on Sep. 5, 2013.
(60) Provisional application No. 61/875,668, filed on Sep. 9, 2013.

(51) Int. Cl. H04L 29/06; H04L 29/08

(52) U.S. Cl. CPC H04L 65/1069; H04L 65/4076; H04L 67/16

(57) ABSTRACT

A method for performing Audio/Video (A/V) streaming between at least one source device and at least one sink device in a wireless communication system, the method performed by a source device comprising: receiving from a sink device an A/V source discovery message for discovering information related to A/V channels that the source device supports; transmitting a response with respect to the A/V source discovery message to the sink device; receiving from the sink device information related to A/V channels selected by the sink device for A/V streaming; performing an A/V stream connection procedure for A/V streaming with the sink device; and transmitting an A/V stream to the sink device by using information related to A/V channels selected by the sink device.

### TECHNICAL FIELD

The present invention is related to a method and an apparatus for performing audio/video streaming in a wireless communication system, more particularly in a Wireless Personal Area Network (WPAN).

### BACKGROUND ART

Recently, Bluetooth technology is widely used. Bluetooth radio waves can penetrate solid and non-metallic materials. The transmission range of the Bluetooth radio wave spans from 10 cm to 10 m, but can be extended up to 100 m if transmission power is increased. Bluetooth technology utilizes a low-cost, short range radio link, and makes ad-hoc access performed easily in a fixed and a mobile communication environment.

Bluetooth uses radio waves of 2.45 GHz in the ISM band, which is the same specification as the wireless LAN 802.11b/g standard. Bluetooth devices perform wireless communication with neighboring Bluetooth devices through a search/selection/authentication (pairing) process.

Bluetooth technology is aimed for relatively fast communication with relatively low power consumption and low costs; since the communication range is limited up to 100 m, it is appropriate for limited-scale communication applications.

Enhanced Data Rate specification has been introduced since the Bluetooth version 2.0 standard, after which Bluetooth technology has been rapidly popularized as communication quality is guaranteed above some predetermined level. As Bluetooth technology is widely adopted, usage of mobile devices equipped with Bluetooth communication function is also growing fast. In particular, short range data communication based on Bluetooth is widely used, one typical example of which is wireless music listening through Bluetooth communication with a Bluetooth headset.

Bluetooth applications are growing: music play through car audio coupled to a smartphone based on Bluetooth communication or music play through Bluetooth docking speaker coupled to a smartphone, to mention a few examples.

Also, Wireless Personal Area Network (WPAN) is capable of transmitting a small amount of data among devices in the environment such as a home network, small office, or vehicular network and thus maximizes energy efficiency.

Also, WPAN is used widely since it is capable of providing a real-time A/V streaming service within limited bandwidth through electronic devices such as headsets and of maximizing energy efficiency even when a remote control function relying on the provided service is performed.

### DISCLOSURE

### Technical Problem

Since most A/V source devices at home such as TV and set-top box provide only a single A/V channel (audio channel), multiple A/V sources (or A/V channels) such as Picture-In-Picture (PIP) or multi-view programs can be played in a very limited way.

In other words, multiple A/V channels such as PIP or multi-view programs require headsets for the respective A/V channels since built-in speakers cannot play such programs.

Meanwhile, WPAN technology such as Bluetooth supporting audio streaming does not support the multi-channel audio streaming and therefore, if WPAN interfaces are provided in proportion to the number of audio channels, unnecessary costs are incurred.

Also, if a source device tries to play multimedia contents through a sink device while another source device is already playing multimedia contents such as audio and video through the same sink device, a user has to put up with inconvenience of manually releasing a connection to the previously connected source device, connecting to the new source device, and pushing the play button of the source device after finding the multimedia contents.

Therefore, the present invention has been made in an effort to provide multi-channel audio streaming through a single WPAN interface such as Bluetooth supporting wireless audio streaming.

In other words, the present invention provides an ID system by which A/V streaming data dependent on the respective A/V channels and remote control data can be managed separately and a system model for supporting multi-channel audio streaming.

Also, the present invention provides a simple pairing method employing NFC between a new source device and a sink device in case a plurality of source devices attempt to play multimedia contents such as audio and video through one sink device.

Also, the present invention provides a method for transition of play control among source devices through stream-related information and a method for playing multimedia streaming played in a source device automatically in a successive manner.

### Technical Solution

In a method for performing Audio/Video (A/V) streaming between at least one source device and at least one sink device in a wireless communication system, the method according to the present invention comprises a source device's performing a device discovery procedure with a sink device; receiving from the sink device an A/V source discovery message for discovering information related to A/V channels that the source device supports; transmitting a response with respect to the A/V source discovery message to the sink device, where the response includes the information related to A/V channels that the source device supports; receiving from the sink device information related to A/V channels selected by the sink device for A/V streaming; performing an A/V stream connection procedure for A/V streaming with the sink device; and transmitting an A/V stream to the sink device by using information related to A/V channels selected by the sink device, where the A/V channel related information includes at least one from among at least one group identification information and at least one stream identification information within each group.

According to the present invention, the A/V channel related information is an identifier (ID) representing at least one of A/V channel and A/V stream.

According to the present invention, the response further comprises a list of available A/V channels.

According to the present invention, the A/V channel related information further comprises a Number of Group ID (NumGID) field representing the total number of groups that the source device supports and a Number of Stream ID (NumSID) field representing the total number of streams that each group provides.

The method according to the present invention further comprises receiving remote control including A/V channel related information related to control of A/V streaming from the sink device; performing control of an A/V stream transmitted to the sink device according to the received remote control; and transmitting a control result of the A/V stream to the sink device.

According to the present invention, the control of the A/V stream is movement to the next A/V stream or to the previous A/V stream.

According to the present invention, reception of the A/V source discovery message and transmission of the response are performed through NFC tagging with the sink device.

According to the present invention, the A/V channel related information is a Stream End Point Identifier (SEID).

The method according to the present invention further comprises performing a Stream End Point (SEP) discovery procedure for performing remote control on the sink device, where the SEP discovery procedure comprises receiving from the sink device an SEP discovery message for discovering an SEP that the source device supports; and transmitting to the sink device a response with respect to the SEP discovery message, where the response includes an SEID list of the source device.

According to the present invention, the remote control is an A/V command message or an A/V command header.

According to the present invention, the A/V command message further comprises at least one of information indicating selection of an SEP and information indicating change of the SEP.

In a method for performing Audio/Video (A/V) streaming between at least one source device and at least one sink device in a wireless communication system, the method according to the present invention comprises a sink device's performing a device discovery procedure with a source device; transmitting to the source device an A/V source discovery message for discovering information related to A/V channels that the source device supports; transmitting to the selected source device an audio source discovery message to discover an audio source that the selected source device supports; receiving a response with respect to the A/V source discovery from the source device, where the response includes information related to A/V channels that the source device supports; selecting A/V channel related information for A/V streaming on the basis of the received response; transmitting the selected A/V channel related information to the source device; and receiving an A/V stream from the source device by using the selected A/V channel related information, where the A/V channel related information includes at least one from among at least one group identification information and at least one stream identification information within each group.

According to the present invention, the source device is a first source device and performs a method comprising pairing NFC tagging with the second source device; receiving SEID of the second source device through pairing; transmitting to the first source device a request for the second device to join A/V streaming; receiving a result with respect to the request from the first source device; and receiving an A/V stream from the second source device on the basis of SEID of the second source device received through the pairing if the received result indicates that the second source device is allowed to join A/V streaming.

According to the present invention, the method further comprises stopping A/V streaming to the sink device.

According to the present invention, the SEID of the second source device is included in the Out-Of-Band (OOB) data of Bluetooth.

According to the present invention, the OOB data further comprises Media Player ID (MPID).

According to the present invention, the source device is a first source device and performs a method further comprising receiving an A/V stream from the first source device through Wi-Fi Direct communication; performing a device discovery procedure through Wi-Fi Direct communication with a second source device; receiving SEID of the second source device through the device discovery procedure and forming a Wi-Fi Direct Network (WFDN) group with the second source device; and receiving an A/V stream from the second source device.

In a method for performing Audio/Video (A/V) streaming between at least one source device and at least one sink device in a wireless communication system according to the present invention, the source device comprises a communication unit for transmitting and receiving a signal with the outside in a wired and/or wireless manner; and a controller connected functionally to the communication unit, where the controller is configured to perform a device discovery procedure with a sink device; to receive from the sink device an A/V source discovery message for discovering information related to A/V channels that the source device supports; to transmit a response with respect to the A/V source discovery message to the sink device, where the response includes the information related to A/V channels that the source device supports; to receive from the sink device information related to A/V channels selected by the sink device for A/V streaming; to perform an A/V stream connection procedure for A/V streaming with the sink device; and to transmit an A/V stream to the sink device by using information related to A/V channels selected by the sink device, where the A/V channel related information includes at least one from among at least one group identification information and at least one stream identification information within each group.

### Advantageous Effects

By defining a new concept of an audio channel ID (ACID), the present invention provides an advantageous effect of supporting multi-channel A/V streaming through a single interface in a multi-A/V channel environment (source device) providing multi-channel programs such as PIP or multi-view contents; and reducing unnecessary costs by obviating the need to provide as many WPAN interfaces as the number of A/V channels.

Also, the present invention provides an advantageous effect of improving user's convenience since devices can be connected automatically through simple NFC tagging and A/V streaming can be played continuously in an autonomous manner.

Also, by newly defining the existing procedure of releasing A/V streaming among devices, the present invention provides an advantageous effect of extending application domains of services based on Bluetooth technology.

### BRIEF DESCRIPTION OF THE DRAWINGS

FIG. 1 illustrates one example of internal block diagrams of a source device and a sink device according to the present invention.

FIG. 2 illustrates internal structures of a source device and a sink device from a functional point of view according to the present invention.

FIG. 3 illustrates a use case of multi-channel audio streaming according to the present invention.

FIG. 4 is another use case of multi-channel audio streaming according to the present invention.

FIG. 5(a) is one example of a multi-channel audio stream using an audio channel ID according to the present invention.

FIG. 5(b) is one example of an audio channel structure of a source device according to the present invention.

FIG. 5(c) is one example of an audio channel ID according to the present invention.

FIG. 5(d) is one example of an audio channel ID set according to the present invention.

FIG. 6 is a flow diagram illustrating one example of a method for performing multi-channel audio streaming according to the present invention.

FIG. 7 is a flow diagram illustrating one example of a method for performing remote control of multi-channel audio streaming according to the present invention.

FIG. 8 is a flow diagram illustrating another example of a method for performing remote control of multi-channel audio streaming according to the present invention.

FIG. 9 is a flow diagram illustrating one example of a method for performing multi-channel audio streaming according to the present invention when multiple sink devices are used.

FIG. 10 is a flow diagram illustrating one example of a method for performing remote control and audio/video streaming in Bluetooth communication.

FIG. 11 is a flow diagram illustrating one example of a method for discovering an SEID for multi-channel audio streaming in Bluetooth communication according to the present invention.

FIG. 12 is a flow diagram illustrating one example of a method for performing remote control of multi-channel audio streaming through an AV/C command including an SEID according to the present invention.

FIG. 13 is a flow diagram illustrating another example of a method for performing remote control of multi-channel audio streaming by designating an SEP within an AV/C command according to the present invention.

FIG. 14 is a flow diagram illustrating one example of a method for changing an SEP in the AVRCP of Bluetooth communication according to the present invention.

FIG. 15 is a flow diagram illustrating one example of a method for changing an SEP in a sink device which does not provide a User Interface (UI) according to the present invention.

FIG. 16 is a flow diagram illustrating one example of a method for performing multi-channel audio streaming through NFC according to the present invention.

FIG. 17 is a flow diagram illustrating one example of a method for performing automatic connection among devices through NFC and automatic play of audio streaming according to the present invention.

FIG. 18 is a flow diagram illustrating another example of a method for performing automatic connection among devices through NFC tagging and automatic play of audio streaming according to the present invention.

FIG. 19 is a flow diagram illustrating one example of a method for automatic connection among devices through NFC and releasing A/V streaming according to the present invention.

FIG. 20 is a flow diagram illustrating another example of a method for automatic connection among devices through NFC and releasing A/V streaming according to the present invention.

FIG. 21 illustrates one example of an output displayed on a source device and a sink device described in FIGS. 19 and 20.

FIG. 22 illustrates one example of a UI implemented in a sink device for automatic connection through NFC and automatic continuous play of A/V streaming according to the present invention.

FIG. 23 is a flow diagram illustrating one example of a method for automatic connection and automatic continuous play of A/V streaming through Wi-Fi Direct.

### MODE FOR INVENTION

In what follows, the present invention will be described in more detail with reference to appended drawings.

A suffix such as “module” and “unit” introduced in the description below is assigned merely to facilitate description of this document, and the “module” and “unit” can be used interchangeably.

Meanwhile, a device according to this document refers to a device capable of wireless communication, including a mobile phone including a smartphone, tablet PC, desktop computer, notebook, and television including a smart TV and IPTV.

In what follows, embodiments of the present invention will be described in detail with reference to appended drawings and descriptions contained in the drawings, but the technical scope of the present invention is not restricted by the embodiments or limited to the embodiments.

Wherever possible, general terms widely used by the public have been chosen as long as the terms do not obscure their technical functions intended in the present invention; however, those terms can be changed by the intention of those skilled in the art, practices, or advent of a new technology.

In some case, specific terms are chosen arbitrarily; in that case, specific meaning of the corresponding terms will be elaborated at the corresponding description.

Therefore, the terms used in this document should be interpreted on the basis of their actual meaning and the description throughout the document rather than the immediate names of the terms.

Internal Block Diagrams of a Source Device and a Sink Device

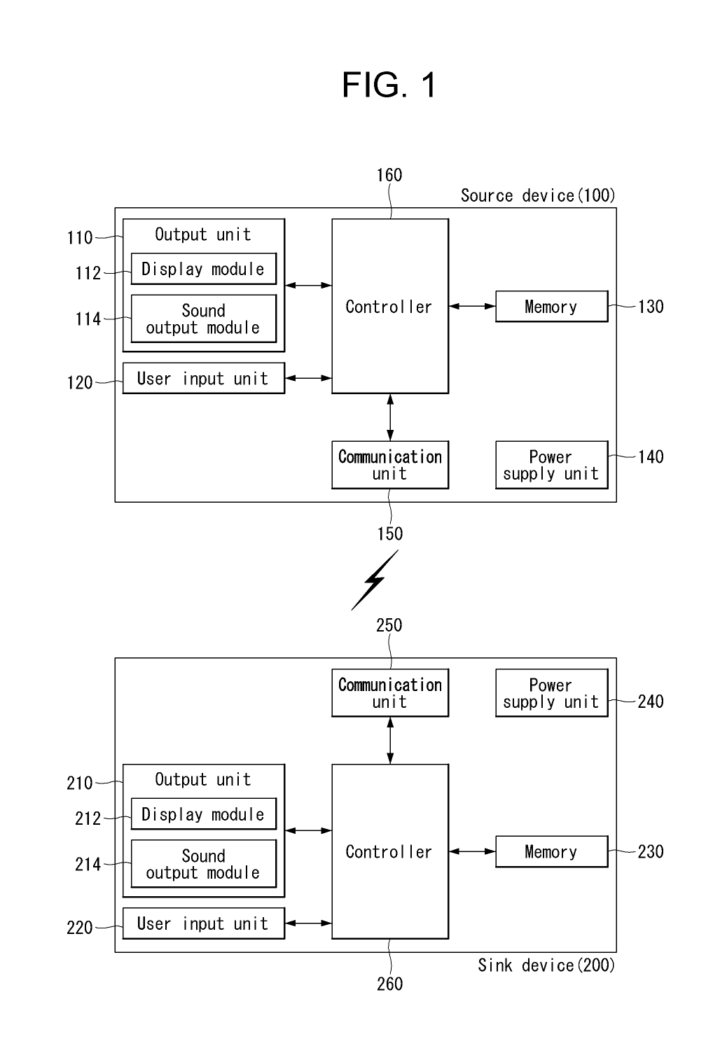

FIG. 1 illustrates one example of internal block diagrams of a source device and a sink device according to the present invention.

A source device (SRC) refers to all kinds of electronic devices capable of storing and transmitting multimedia data such as audio/video data.

A sink device (SNK) refers to all kinds of electronic devices capable of receiving and outputting (or playing) multimedia data such as audio/video data.

The source device or the sink device can be defined as a controller (CT) or a target (TG) depending on its function or usage.

In this case, the controller refers to a device which initiates a transaction by transmitting a command frame to the target, where the controller can be a personal computer, PDA, mobile phone, remote controller, or A/V device (for example, a car system, headphone, player/recorder, timer, tuner, or monitor).

Also, the target refers to a device which receives a command frame and transmits a response frame according to the received command frame, where the target can be an audio player/recorder, video, player/recorder, TV, tuner, amplifier, or headphone.

Also, the source device or the sink device may be defined as an initiator (INT) or an acceptor (ACP) in a specific procedure.

An initiator refers to a device which initiates a procedure by transmitting a particular message, and an acceptor refers to a device which receives the particular message.

Each of the source device and the sink device can comprise an output unit 110, 210, user interface unit 120, 220, memory 130, 230, power supply unit 140, 240, communication unit 150, 250, and a controller (processor) 160, 260.

The output unit, user interface unit, memory, power supply unit, communication unit, and controller are connected functionally to each other to perform a method according to the present invention.

The constituting elements shown in FIG. 1 are not necessarily indispensable; thus, an electronic device can be implemented with more or fewer elements than are illustrated in the figure.

The output unit 110, 210 generates an output related to visual, aural, or tactile sense, which may include a display module 112, 212 or a sound output module 114, 214.

The display module 112, 212 displays information processed in the device. For example, if the device is in a conversation mode, the device displays a User Interface (UI) or a Graphic User Interface (GUI) related to conversation. If the device is a video communication mode or an image capture mode, the display module displays a captured and/or received image, UI, or GUI.

The display module 112, 212 can include at least one of liquid crystal display, thin film transistor liquid crystal display, organic light emitting diode, flexible display, and 3D display.

The sound output module 114, 214 may output audio data from call signal reception; audio data received from the communication unit 150, 250 in a voice communication mode, recording mode, voice recognition mode, or broadcast reception mode; or audio data stored in the memory 130, 230. The sound output module 114, 214 outputs a sound signal related to a function performed in the device (for example, a call signal receiving sound and a message receiving sound). The sound output module 114, 214 can include a receiver, speaker, and buzzer.

The sink device 200 can output multimedia contents received from the source device 100 through the output unit 110, 210 according to a wireless streaming scheme.

The user input unit 120, 220 generates input data for the user to control operation of the device. The user input unit 120, 220 can comprise a keypad, dome switch, (resistive/capacitive) touch pad, jog wheel, and jog switch.

The memory 130, 230 can store a program for operation of the controller 160, 260 and can temporarily store input/output data. The memory 130, 230 can store data related to vibration and sound of various patterns generated when a touch input is applied on the touch screen.

The memory 130, 230 is a medium for storing various pieces of information for a device, and being connected to the controller, can store programs for operation of the controller 160, 260, applications, general files, and input/output data.

The memory 130, 230 can include at least one type of storage medium from among flash memory type, hard disk type, multimedia card micro type, card type memory (for example, SD or XD memory), Random Access Memory (RAM), Static Random Access Memory (SRAM), Read Only Memory (ROM), Electrically Erasable Programmable Read Only Memory (EEPROM), Programmable Read Only Memory (PROM), magnetic memory, magnetic disk, and optical disk. The device may operate in conjunction with a web storage which performs a storage function of the memory 130, 230 on the Internet.

The source device 100 can store multimedia contents to the memory 130, output the stored multimedia contents through the output unit 110 of the source device 100, and output the stored multimedia contents through the output unit 210 of the sink device 200 by using a wireless streaming method.

The power supply unit 140, 240 refers to a module which receives external power and internal power under the control of the controller 160, 260 and supplies power required for operation of each constituting element.

The communication unit 160, 260 can include one or more modules which enable wireless communication between a device and a wireless communication system or between a device and a network to which the device belongs. For example, the communication unit 160, 260 can include a broadcast receiving module (not shown), a mobile communication module (not shown), a wireless Internet module (not shown), and a short range communication module (not shown).

The communication unit 160, 260 can be called a transmission/reception unit.

The mobile communication module transmits and received a radio signal to and from at least one of a base station, an external terminal, or a server on a mobile communication network. The radio signal can be a voice call signal, video communication call signal, or various types of data according to transmission and reception of a text/multimedia message.

The wireless Internet module refers to a module for wireless Internet connection and can be installed inside or outside a device. Wireless LAN (WLAN,WiFi), Wireless broadband (Wibro), World Interoperability for Microwave Access (Wimax), High Speed Downlink Packet Access (HSDPA) can be used as a wireless Internet technology.

The device can establish a Wi-Fi Peer-to-Peer (P2P) connection with other devices through the wireless Internet module. Through the Wi-Fi P2P connection, the device can provide inter-device streaming services and through data transmission/reception or being connected to a printer, can provide a printing service.

The short rage communication module refers to a module for short range communication. Bluetooth, Radio Frequency Identification (RFID), Infrared Data Association (IrDA), Ultra Wideband (UWB), or ZigBee can be used as a short range communication technology.

The source device 100 and the sink device 200 can output multimedia contents by data exchange based on Bluetooth communication and a wireless streaming method.

The controller 160, 260 refers to a module which controls the overall operation of the source device 100 or the sink device 200 and is capable of controlling the device to request transmission of a message through a Bluetooth interface and other communication interface and to process a received message.

The controller 160, 260 can be called a micro controller or a microprocessor and can be implemented by hardware, firmware, software, or a combination thereof.

The controller 160, 260 can include Application-Specific Integrated Circuit (ASIC), other chipsets, logical circuit and/or data processing device.

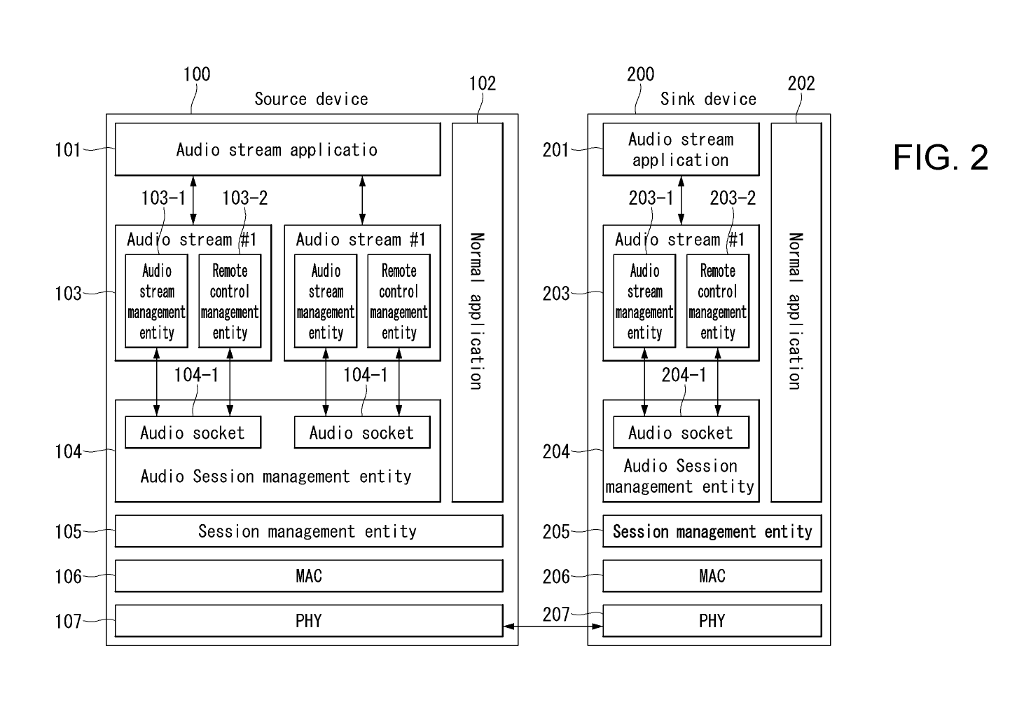

FIG. 2 illustrates internal structures of a source device and a sink device from a functional point of view according to the present invention.

Each of the source and the sink device comprises an audio stream application entity 101, 201, audio stream entity 103, 203, audio session management entity 104, 204, normal application entity 102, 202, session management entity 105, 205, MAC layer 106, 206, and PHY layer 107, 207.

The source device can include a plurality of audio stream entities (Audio Stream #1, . . . , Audio Stream #N) for multi-channel audio streaming of the present invention.

The audio stream entity 103, 203 includes an audio stream management entity 103-1, 203-1 and a remote control management entity 103-2, 203-2.

The audio session management entity 104, 204 further comprises an audio socket 104-1, 204-1.

The audio stream management entity and the remote control management entity can be connected to the audio session management entity through the audio socket, respectively.

The entity can be called a “module” or a “unit”.

Internal structures of the source and the sink device from a functional point of view will be described in detail in conjunction with descriptions of the methods according to the present invention.

Multi-Channel Audio Streaming

In what follows, described in detail will be a method for performing multi-channel audio streaming through a single interface in a WPAN which supports wireless audio streaming according to the present invention.

Multi-channel audio streaming operates such that a single source device provides multiple audio channels and/or multiple audio streams, where a single source device provides multiple audio channels and each audio channel provides multiple audio streams.

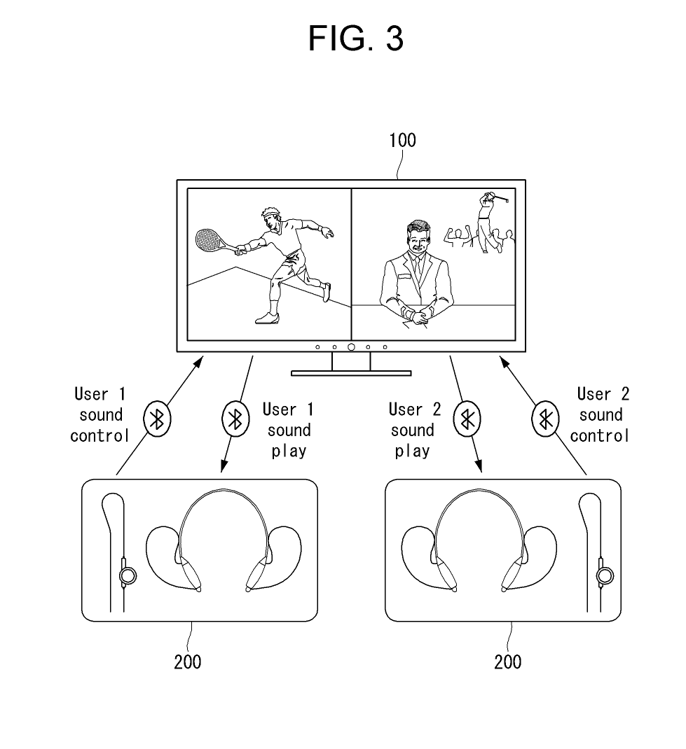

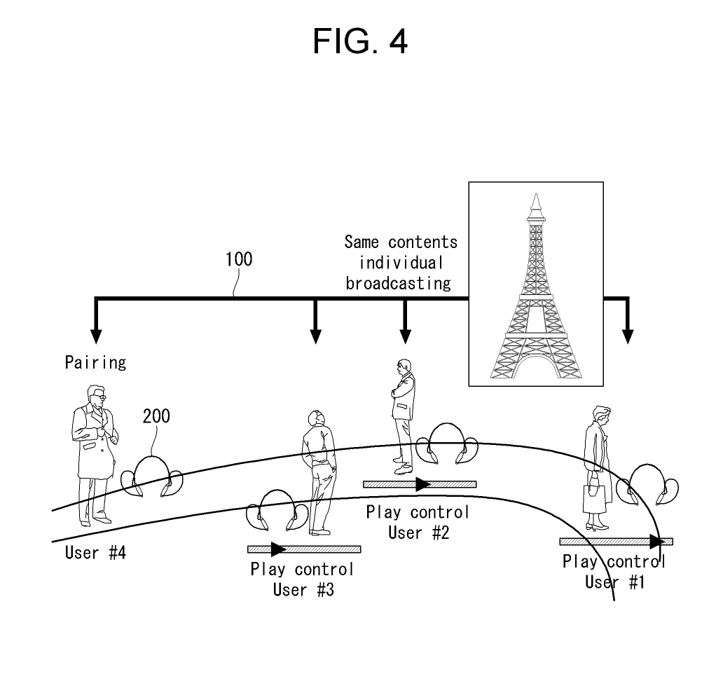

With reference to FIGS. 3 and 4, use cases of multi-channel audio streaming will be described.

FIG. 3 illustrates a use case of multi-channel audio streaming according to the present invention.

Multi-channel audio streaming can be performed by a single source device and at least one sink device.

The source device is an electronic device capable of providing multiple audio sources such as Picture-In-Picture (PIP) or multi-view contents, namely multiple contents or multiple screens/voices, an example of which is TV.

The sink device is an electronic device capable of being connected wirelessly to TV corresponding to a source device, playing an audio stream that the TV provides, and performing remote control of the corresponding audio stream, an example of which includes a wireless sound device such as a headset. In the case of FIG. 3, the wireless sound device and the TV perform Bluetooth communication.

The user 1 and user 2 can independently receive an audio stream that the TV provides through a wireless sound device and control the received audio stream through remote control of the wireless sound device.

In case multi-channel audio streaming of the present invention is supported, each user can (1) receive and play an audio stream that the user wants and (2) remotely control each screen of multi-views of TV by using a remote controller through the wireless sound device.

More specifically, in the use case of (1), each user can select a specific screen of the TV and play a selected audio stream through a wireless sound device such as a Bluetooth headset.

If a wireless headset such as a Bluetooth headset is not available, each user can play the sound of a selected channel by using a portable device instead of the wireless sound device.

In the use case of (2), the user can play and control desired contents by remotely controlling the respective, divided TV screens by using a remote controller.

FIG. 4 is another use case of multi-channel audio streaming according to the present invention.

As shown in FIG. 4, in case a tourist site support multi-channel audio streaming, tourists arriving at the tourist site at different times still can receive the same contents according to their arrival times, and the tourists can remotely control the corresponding contents through a remote controller.

In other words, each time a tourist arrives the tourist site, one source device is paired newly with a sink device carried by the tourist, after which the tourist can listen to a guide voice provided at the tourist site from the start and control the guide voice through remote control.

Since multiple audio streams can be provided from the respective audio channels, users can listen to a guide voice in different languages through the same audio channel.

As an example, if the source device supports multiple languages such as Korean, English, and Chinses, the user at the tourist site can listen to a guide voice in a language that the user wants.

Audio Channel ID: ACID

In what follows, an Audio Channel ID (ACID) is newly defined, and described in detail will be a method for performing multi-channel audio streaming through a single interface in a WPAN network environment by using the ACID.

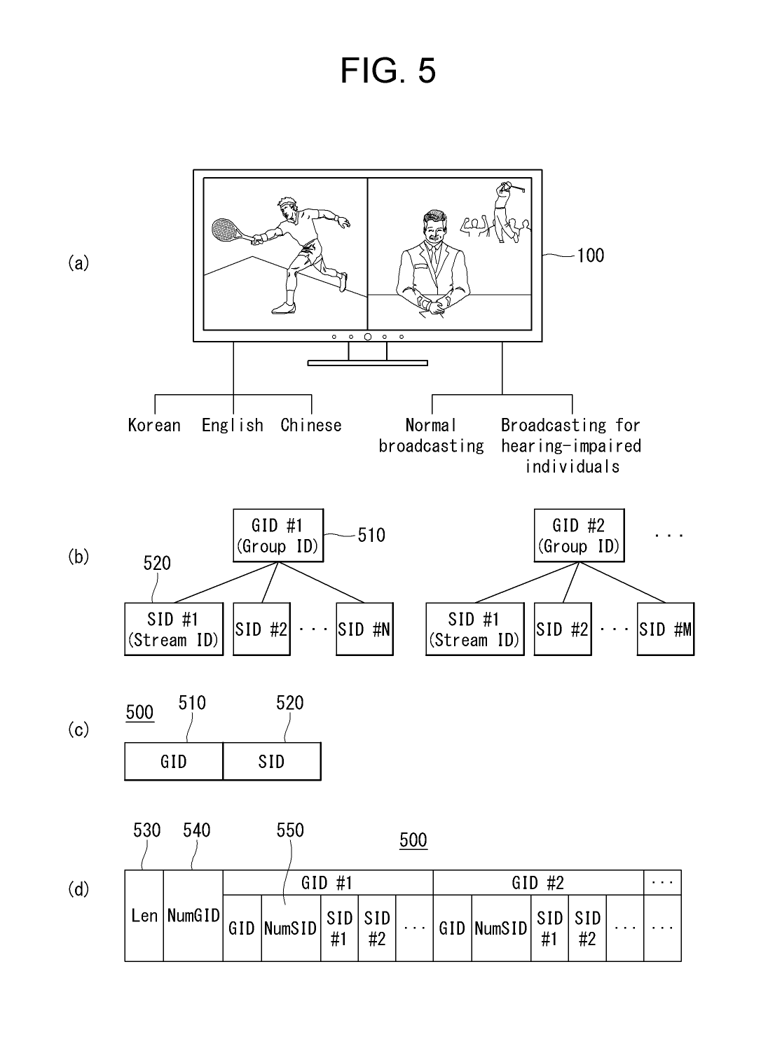

FIG. 5(a) is one example of a multi-channel audio stream using an audio channel ID according to the present invention, FIG. 5(b) is one example of an audio channel structure of a source device according to the present invention, FIG. 5(c) is one example of an audio channel ID according to the present invention, FIG. 5(d) is one example of an audio channel ID set according to the present invention.

A source device such as TV supporting a PIP function or a set-top box supporting multi-view screens can provide multiple screens in one screen, namely multiple contents.

At this time, contents provided through one screen can provide a multi-sound function through multiple audio channels.

As shown in FIG. 5(a), a particular TV screen provides a multi-lingual function in Korean, English, or Chinese, and another TV screen provides a multi-sound function such as normal broadcasting, broadcasting for hearing-impaired individuals, or direct version which is the same as a movie.

The multi-channel function can allocate one audio channel for each particular audio sound.

In the example of TV described in FIG. 5(a), the source device corresponding to the TV can have an audio channel structure of FIG. 5(b) to provide the multi-audio function for each audio channel.

As shown in FIG. 5(b), an audio channel of the source device can comprise at least one group and at least one stream within each group.

At this time, each group is identified by a group ID (GID), and each stream within each group is identified through a stream ID (SID or SEID).

One group may denote one screen, one audio channel, or one contents that the source device provides.

One stream may denote one audio stream provided by one screen, one audio channel, or one contents.

As one example, one source device can have groups of GID #1 to GID #N and audio channels including streams of SID #1 to SID #N for each group.

Therefore, as shown in FIG. 5(c), an audio channel ID (ACID, 500) of a source device includes GID 510 and SID 520, and in the case of multiple GIDs and SIDs, ACID can be implemented in the form of ACID_set as shown in FIG. 5(d).

In other words, ACID_Set is the information including all ACIDs that one source device supports, comprising a Length field 530 representing the total length of the ACID_Set, NumGID field 540 representing the total number of GIDs, NumSID field 550 representing the total number of SIDs included for each GID, and SID specific information field indicating GID configuration information field representing each GID and SID value, SID configuration information field, and specific information for each SID.

At this time, the specific information for each SID can further comprise a Language Type field indicating language type of each stream, Record Type field, Favorite Channel field related to the user's preference, Favorite Attribute field, Favorite Volume field, Equalizer, and channel information (5.1 CH).

Also, specific information for each SID can be positioned all at once right after the corresponding SID field, right before the corresponding SID, or after the very last SID field.

System Model for Multi-Channel Audio Streaming

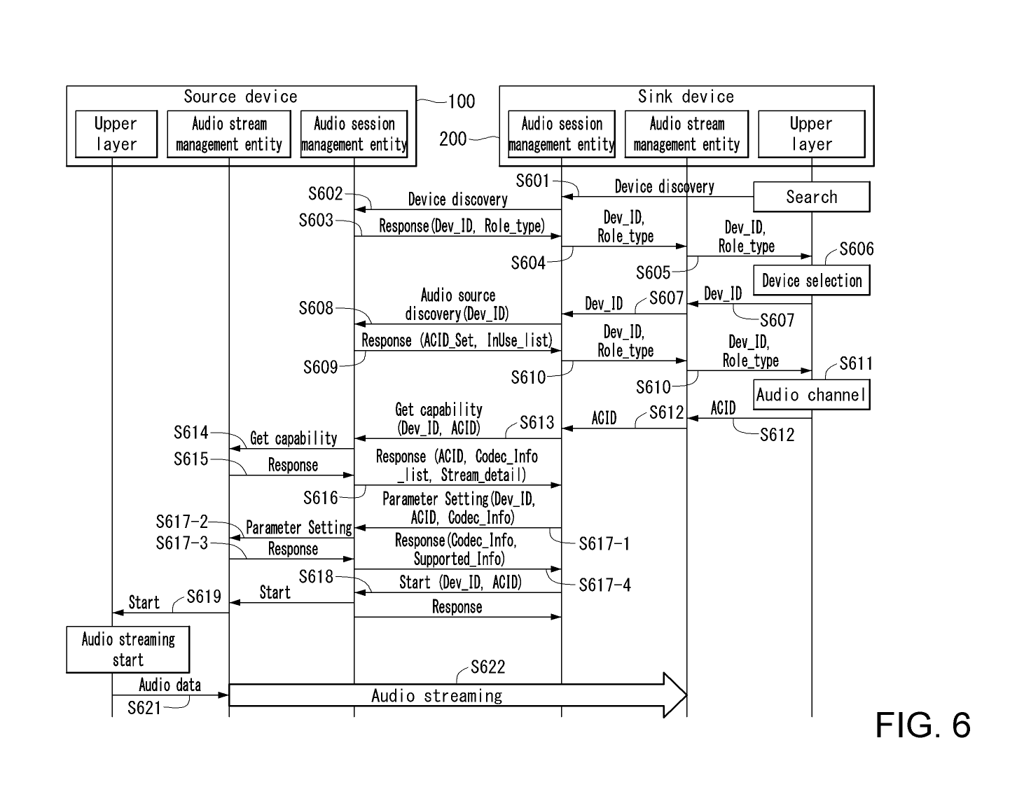

A method for performing multi-channel audio streaming by using the Audio Channel ID (ACID) described above will be described in detail with reference to FIGS. 6 to 9.

FIG. 6 is a flow diagram illustrating one example of a method for performing multi-channel audio streaming according to the present invention.

As described in FIG. 2, a source device and a sink device comprises an upper layer, audio stream management entity, and audio session management entity respectively to perform multi-channel audio streaming. At this time, the entity can be denoted as a ‘module’ or a ‘unit’, and signaling between internal entities within one device can be represented by primitive, message, information, signal, or command. Also, the upper layer can represent an application layer.

First, in case a search is performed in the upper layer of the sink device, the upper layer of the sink device transmits device discovery to discover a source device to the audio session management entity of the sink device S601.

Afterwards, the audio session management entity of the sink device transmits information received at the S601 step to the audio session management entity of the source device S602.

Afterwards, the audio session management entity of the source device transmits a response with respect to the device discovery received from the sink device to the audio session management entity of the sink device S603.

The response can include a device ID (Dev_ID) for identifying a device and a role type parameter (Role_type) indicating the role of the device.

Afterwards, the audio session management entity of the sink device transmits the information received from the S603 step to the audio stream management entity of the sink device S604, and the audio stream management entity of the sink device transmits the information received from the S604 step to the upper layer of the sink device S605.

Afterwards, the upper layer of the sink device selects a device for receiving audio streaming on the basis of the information received from the S605 step S606.

Afterwards, the sink device transmits a device ID representing the selected device through an internal entity S607, and the audio session management entity of the sink device transmits audio source discovery including the ID of the selected device to the audio session management entity of the source device S608.

Afterwards, the audio session management entity of the source device transmits a response with respect to the audio source discovery to the audio session management entity of the sink device S609.

At this time, the response includes ACID_Set information that the source device supports and an ACID list (InUse_list) that can be used by the sink device.

Afterwards, the sink device transmits information including a device ID of a source device which receives audio streaming and information including the Role_Type parameter representing the role of the source device through internal entities on the basis of the information received from the S609 step, S610.

Next, the sink device selects an audio channel for receiving audio streaming on the basis of the information received from the S610 step, S611.

Next, in case an audio channel is selected in the upper layer of the sink device, the sink device transmits information including the ACID corresponding to the selected audio channel through internal entities S612.

Next, the audio session management entity of the sink device transmits the ACID received from the S612 step and a Get Capability message including the device ID to the audio session management entity of the source device S613.

Next, the audio session management entity of the source device transmits information from the S613 step to the audio stream management entity of the source device S614.

Next, the audio stream management entity of the source device transmits a response with respect to the Get Capability message to the audio session management entity of the source device S615.

Next, the audio session management entity of the source device transmits a response including ACID related to the audio channel selected by the sink device, CODEC information list (Codec_Infor_List), and stream data to the audio session management entity of the sink device S616.

Next, the sink device performs a parameter configuration procedure with the source device S617.

More specifically, the audio session management entity of the sink device transmits a parameter setting message (Set Parameter) to the audio session management entity of the source device S617-1.

The Set Parameter message can include a device ID, ACID corresponding to an audio channel, and CODEC information.

Next, the session management entity of the source device transmits information received from the S617-1 step to the audio stream management entity of the source device S617-2.

Next, the audio stream management entity of the source device transmits a response with respect to the Set Parameter message to the audio session management entity of the source device S617-3 and transmits a response including CODEC information (Codec_Info) and supported information (Supported_Info) to the audio session management entity of the sink device S617-4.

Next, the audio session management entity of the sink device transmits an audio stream start message to the audio session management module of the source device S618, and the start message can include a device ID and an ACID corresponding to the audio channel.

Next, the source device transmits the start message through internal entities S619, and in case audio streaming is started in the upper layer of the source device S620, the audio stream management entity of the source device performs S622 audio streaming to the sink device through audio data transmission S621.

Next, described will be a remote control method for controlling an audio stream while multi-channel audio streaming is being performed.

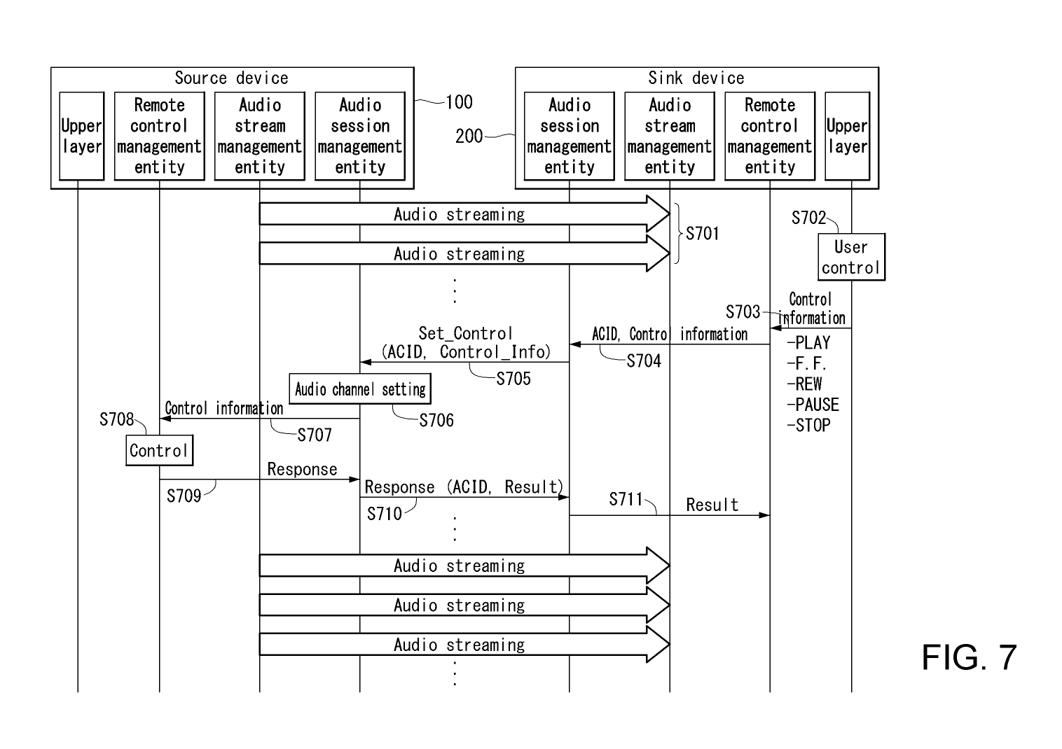

FIG. 7 is a flow diagram illustrating one example of a method for performing remote control of multi-channel audio streaming according to the present invention.

As described in FIG. 2, a source device and a sink device of FIG. 7 comprises an upper layer, remote control management entity, audio stream management entity, and audio session management entity respectively.

As shown in FIG. 7, the sink device receives audio streaming from the source device through the audio stream management entity S701.

Next, in case the upper layer of the sink device receives user control related to audio stream S702, the upper layer of the sink device transmits the user control related information (Control_Info) to the remote control management entity of the sink device S703.

The user control related information can include play, Fast Forward (FF), Rewind (REW), PAUSE, or STOP of the audio stream; or control of acoustic field or equalizer in the sink device.

Next, the remote control management entity of the sink device transmits the user control related information ACID to the audio session management entity of the sink device S704.

Next, the audio session management entity of the sink device transmits a control setting message (Set_Control) including the information from the S704 step to the audio session management entity of the source device S705.

Next, the audio session management entity of the source device selects an audio channel on the basis of the received user control setting message S706 and transmits the control information (Control_Info) related to the selected audio channel to the remote control management entity of the source device S707.

Next, the remote control management entity of the source device performs the corresponding control on the basis of the control information received from the S707 step and transmits the control result to the audio session management entity of the source device S709.

Next, the audio session management entity of the source device transmits a response with respect to the control result to the audio session management entity of the sink device S710. The response can further comprise ACID.

Next, the audio session management entity of the sink device transmits the response at the S710 step to the remote control management entity of the sink device S711.

Through the steps S702 to S711, the sink device can perform control of the audio stream corresponding to the user control.

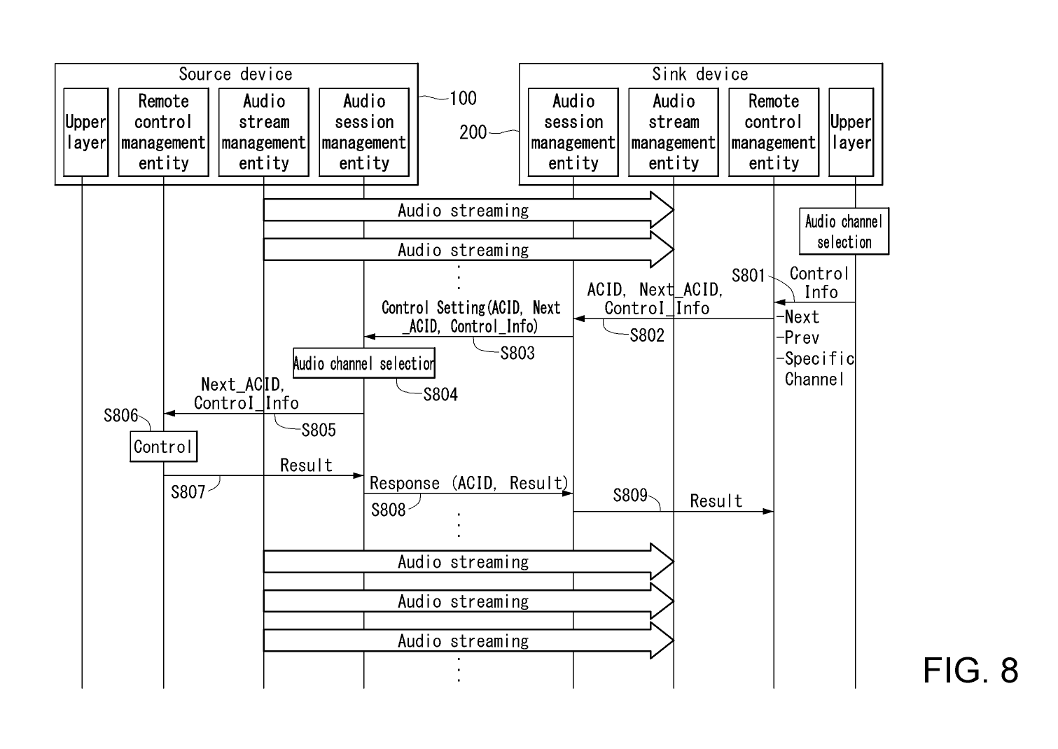

FIG. 8 is a flow diagram illustrating another example of a method for performing remote control of multi-channel audio streaming according to the present invention.

FIG. 8 illustrates a method for performing remote control of an audio stream in a sink device which particularly is not equipped with a User Interface (UI).

As shown in FIG. 8, in case an audio channel is changed in the upper layer of a sink device, the upper layer of the sink device transmits control information related to the audio channel change to the remote control management entity of the sink device S801.

At this time, since the sink device does not have a UI, the control information can include only the information which can be performed without the UI, such as Next, Previous, or Specific Channel.

Next, the remote control management entity of the sink device transmits ACID of a current audio channel (Current_ACID), ACID of the next audio channel to be changed (Next_ACID), and control information related to audio channel change to the audio session management entity of the sink device S802.

Next, the audio session management entity of the sink device transmits a remote control setting (Set_Control) message including the information from the S802 step to the audio session management entity of the source device S803.

Next, the audio session management entity of the source device selects an audio channel on the basis of the information received from the S803 step, S804 and transmits Next_ACID corresponding to the selected audio channel and control information related to audio channel change to the remote control management entity of the source device S805.

Next, the remote control management entity of the source device changes an audio channel according to the request of the sink device S806 and transmits a result of audio channel change to the audio session management entity of the source device S807.

Since the S808 and S809 steps are the same as the S710 and the S711 steps of FIG. 7, descriptions thereof will be omitted.

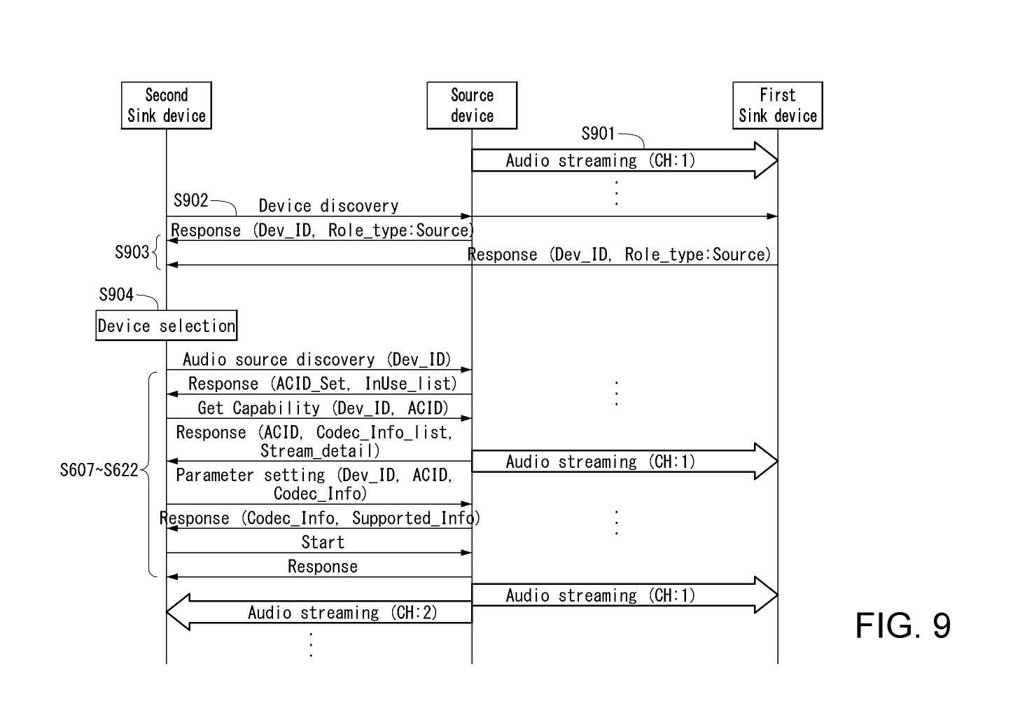

FIG. 9 is a flow diagram illustrating one example of a method for performing multi-channel audio streaming according to the present invention when multiple sink devices are used.

In other words, FIG. 9 illustrates a method for providing audio streaming from one source device to a first and a second sink device respectively through different audio channels.

As shown in FIG. 9, the source device provides audio streaming to the first sink device through an audio channel 1 (CH:1) S901.

In what follows, described in detail will be a method for providing audio streaming to the second sink device (or #N, where N is a natural number larger than 1) simultaneously to the first sink device while the S901 step is being performed.

The source device receives device discovery from the second sink device while providing an audio streaming service to the first sink device S902. The second sink device can also transmit the device discovery to the first sink device.

Next, the second sink device receives a response with respect to the device discovery transmitted to the source device from the source device and/or the first sink device S903.

The device discovery response transmitted respectively from the first sink device and the source device to the second sink device includes a device ID indicating a device and a role type parameter indicating the role of the corresponding device.

Next, the second sink device selects a device for receiving audio streaming on the basis of the response received from the S903 step, S904.

In the case of FIG. 9, it indicates that the second sink device has selected the source device.

Next, by performing the steps corresponding to S607 to S622 of FIG. 6 (audio source discovery procedure, get capability procedure, parameter setting procedure, audio streaming start procedure, and so on) with the source device, the second sink device receives audio streaming from the source device through the audio channel 2 (CH:2).

At this time, the second sink device may use a pairing method defined in the Bluetooth communication while establishing a connection to the source device, but the second sink device may perform a pairing procedure with the source device by using NFC.

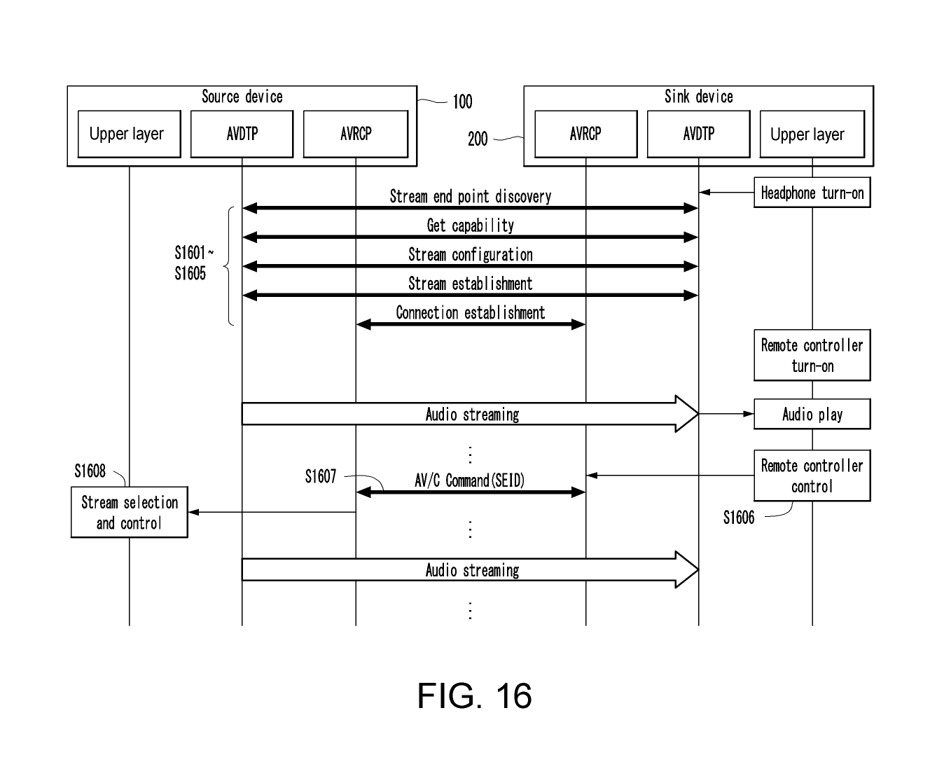

In other words, after performing pairing with the second sink device through NFC tagging, the source device can receive an audio streaming service through the audio channel 2 from the source device. A pairing procedure through NFC tagging between a source device and a sink device and an A/V streaming method based on the pairing procedure will be described in detail later with reference to FIG. 16.

Also, the second sink device can receive the audio streaming service as provided to the first sink device from the source device through the same audio channel (CH:1) or through a different audio channel (CH:2).

Also, in case the source device is paired with the second sink device through NFC tagging, the source device can stop audio streaming with the first sink device, but continuously play the audio streaming through the second sink device.

Method for Supporting Multi-Channel Audio Streaming in Bluetooth Communication

In what follows, described in detail will be a method for supporting multi-channel audio streaming utilizing the methods described above with respect to Bluetooth communication supporting wireless audio streaming.

First, an A/V stream signal transmission method and an A/V device remote control method defined in the Bluetooth communication will be described with reference to the A2DP (Advanced Audio Distribution Profile), AVDTP (Audio/Video Distribution Transport Protocol), AVRCP (Audio Video Remote Control Profile), and AVCTP (Audio/Video Control Transport Protocol).

Bluetooth profile includes HSP (Headset Profile), HFP (Hands Free Profile), A2DP (Advanced Audio Distribution Profile), and AVRCP (Audio Video Remote Control Profile), which are divided largely into the functions for voice communication and the functions for music listening.

The Bluetooth profile defines a protocol type that has to be used for a specific application when Bluetooth applications are implemented, protocol structure, and methods of using the protocol.

HSP and HFP are profiles for voice communication and support functions of receiving, hanging up, and re-dialing a call. At this time, the HSP is the most common profile intended for voice communication and mono-sound music, mostly used for Bluetooth mono-headset.

HFP is the profile more advanced than the HSP profile, supporting voice dialing, re-dialing, call switching, call receiving/hanging-up.

If both of the HSP and HFP profiles are supported, hands-free functions such as call receiving, hang-up, and re-dialing can be utilized while mono-quality sound is delivered at the same time.

A2DP and AVRCP are intended to deliver stereo sound and support functions such as playing, stopping, and volume control. At this time, the A2DP is the profile supporting stereo music, devised to transmit stereo audio streams.

In the A2DP profile, a device transmitting audio data is defined as a source (SRC) device, and a device receiving audio data such as a Bluetooth headset is defined as a sink (SNK) device. In other words, the A2DP is the profile supporting audio data transmission from the source device to the sink device.

AVDTP (Audio/Video Distribution Transport Protocol) is the Bluetooth protocol specifying transmission of A/V stream signals and is included in the A2DP.

AVRCP (Audio Video Remote Control Profile) is the profile supporting remote control.

The AVRCP has been devised to provide a standard interface such that it controls devices such as TV or set-top boxes, allows single remote control, and controls all kinds of A/V devices accessed by the user.

In the AVRCP, a source device or a sink device is defined as a controller (CT) or a target (TG).

A controller refers to a device which initiates transactions by transmitting a command frame to a target, where the controller can be a personal computer, PDA, mobile phone, remote controller, or A/V device.

The A/V device can be a car system, headphone, player/recorder, timer, tuner, or monitor.

A target refers to a device which receives a command frame and transmits a response frame in response to the received command frame, where the target can be an audio player/recorder, video, player/recorder, TV, tuner, amplifier, or headphone.

AVRCP is the profile which supports a controller to transmit a command such as FF (Fast Forward), REW (Rewind), Play, Pause, and generating a playlist to a target; and to wirelessly control playing audio data of the target.

AVCTP (Audio/Video Control Transport Protocol) is the Bluetooth protocol specifying control of A/V devices, which is included in the AVRCP.

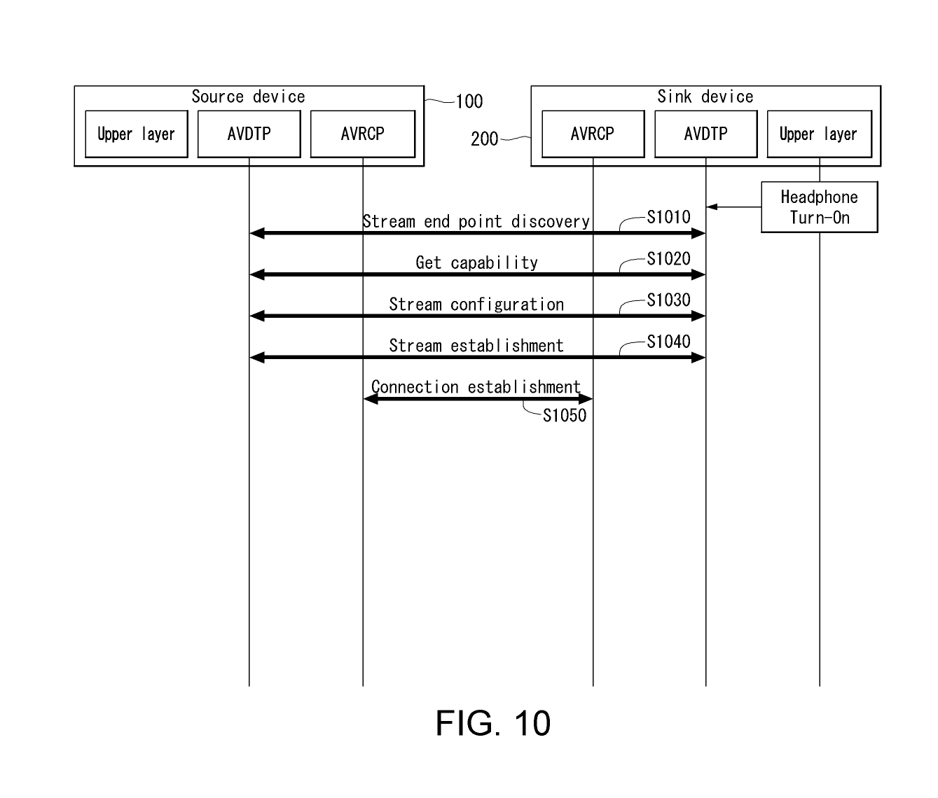

With reference to FIG. 10, a method for transmitting an A/V signal and controlling an A/V device in the Bluetooth communication will be described.

FIG. 10 is a flow diagram illustrating one example of a method for performing audio/video streaming and remote control in Bluetooth communication.

AVDTP signaling is carried out in the step before actual data transmission; and is used to determine to which format (system) a Bluetooth device responds, to negotiate by determining a device capable of receiving data to be transmitted from an upper layer (application), and to set up a connection to a logical link management layer.

Also, AVRCP connection establishment procedure is performed among A/V devices for control of A/V devices, and when the AVRCP connection is established, A/V devices transmit an AV/C command for remote control.

With reference to FIG. 10, the source device and the sink device perform a stream end point discovery procedure for A/V stream connection S1010.

At this time, a stream or a Bluetooth A/V stream refers to a logical end-to-end connection of A/V multimedia data streaming between Bluetooth devices (source device and sink device).

A Stream End Point (SEP) refers to an interface of an A/V device for a data stream and can indicate a transmission service or an A/V service supported by a Bluetooth device.

Interfaces of data transmitting devices can be regarded as individual stream end points, and an stream end point is identified by Stream End Point Identifier (SEID).

Through the stream end point discovery procedure, the source device or the sink device can obtain information about which type (system or format) of streams a device to be connected supports.

Messages used in the stream end point discovery procedure include an AVDTP discovery command (AVDTP_Discovery_CMD) message for obtaining stream end point information of a target device and an AVDTP discovery response (AVDTP_DISCOVERY_RSP) message transmitted in response to the AVDTP_Discovery_CMD message.

The AVDTP_DISCOVERY_RSP message can include an SEID value and an InUse parameter indicating whether the SEID value has been used.

Next, the source device and the sink device performs a Get Capabilities procedure S1020.

Through the Get Capabilities procedure, the source device or the sink device obtain detailed information about the SEP and matches the obtained information to the SEP information that the source or the sink device supports.

Messages used in the Get Capabilities procedure include an AVDTP_GET_CAPABILITIES_CMD message for requesting detailed information about the SEP and an AVDTP_GET_CAPABILITIES_RSP message transmitted in response to the AVDTP_GET_CAPABILITIES message.

Next, the source device and the sink device perform a stream configuration procedure S1030.

Through the stream configuration procedure, the source device or the sink device transmit the SEP information matched through the GET Capabilities procedure and detailed information about matched multimedia codec to their corresponding devices.

Messages used in the stream configuration procedure include an AVDTP_SET_CONFIGURATION_CMD message and an AVDTP_SET_CONFIGURATION_RSP message transmitted in response to the AVDTP_SET_CONFIGURATION_CMD message.

Next, the source device and the sink device perform a stream establishment procedure S1040.

Both of the source device and the sink device enter an open state through the stream establishment procedure, and a streaming channel through which a data (or multimedia) stream can be transmitted and received in real-time is connected.

Messages used in the stream establishment procedure include an AVDTP_OPEN_CMD message for streaming channel connection and an AVDTP_OPEN_CMD_RSP message transmitted in response to the AVDTP_OPEN_CMD message.

An A/V streaming channel is connected between the source device and the sink device through the stream establishment procedure, and the source device or the sink device can play A/V streams.

Next, the source device and the sink device perform an AVRCP connection establishment procedure for performing remote control S1050.

The AVRCP connection establishment procedure is initiated by an event generated by the user, such as an internal event or power-on event.

The A2DP and AVDTP which specify transmission of audio streams in the Bluetooth communication define the ACID described above as an stream end point ID (SEID). However, the SEID does not have a hierarchical structure such as group included within the ACID.

Therefore, to apply multi-channel audio streaming according to the present invention to the A/V streaming defined for Bluetooth communication, the SEID will be employed instead of the ACID.

In other words, it is assumed that the ACID described in FIG. 5 includes only the stream ID (SID or SEID).

Also, since the A2DP and the AVDTP of the Bluetooth communication define the SEID, specifics related to A/V stream transmission can be applied to multi-channel audio streaming without causing a problem. However, in the case of the AVRCP and the AVCTP defining remote control of the Bluetooth communication, the SEID is not used; therefore, remote control cannot be applied to multi-channel audio streaming.

Therefore, in order to apply remote control to multi-channel audio streaming in the Bluetooth communication, the stream end point discovery procedure, by which SEID information that a source device supports, has to be newly defined for the AVRCP of the sink device.

Also, described will be a method for performing remote control on multi-channel audio streaming by adding an SEID or designating an SEP at the time of transmitting an AV/C (AV/C Digital Interface Command Set) Command according to the AVRCP.

In other words, described will be two cases of using the SEID transmission method for a sink device: (1) the case where SEID is included in the AVRCP AV/C command header and (2) the case where SEID is transmitted through an A/V command so that a source device can determine the SEID.

SEID (Stream End Point Identifier) Discovery Procedure

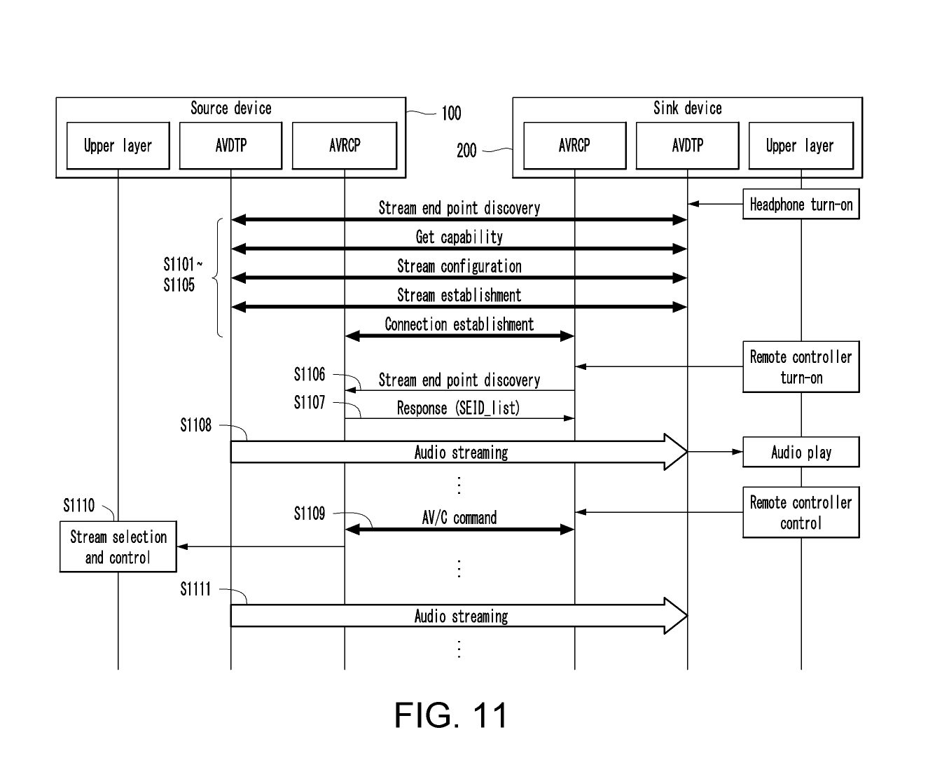

First, the SEID discovery procedure defined in the AVRCP for performing remote control on multi-channel audio streaming in the Bluetooth communication will be descried with reference to FIG. 11.

FIG. 11 is a flow diagram illustrating one example of a method for discovering an SEID for multi-channel audio streaming in Bluetooth communication according to the present invention.

Since S1101 to S1105 steps are the same as the S1010 to S1050 steps of FIG. 10, detailed descriptions thereof will be omitted.

After the S1105 step, if the upper layer of the sink device detects turn-on of a remote controller, the sink device and the source device perform an SEID discovery procedure S1106.

In other words, the AVRCP of the sink device transmits an Stream End Point (SEP) discovery message to the AVRCP of the source device to find SEPs that the source device supports.

Next, the AVRCP of the source device transmits a response with respect to the SEP discovery message to the AVRCP of the sink device S1107, and the response to the SEP discovery message includes SEID list information that the source device supports.

Through the step above, the sink device can obtain the SEID that the source device supports.

If remote control occurs in the upper layer of the sink device while the sink device is receiving an audio streaming service from the source device S1108, the AVRCP of the sink device transmits an AV/C command for the remote control to the AVRCP of the source device S1109.

Next, the upper layer of the source device performs control by selecting a stream related to the remote control on the basis of the received AV/C command S1110.

Next, the AVDTP of the source device provides audio streaming to the AVDTP of the sink device according to the S1110 step S1111.

SEID Transmission and SEP Designation Method

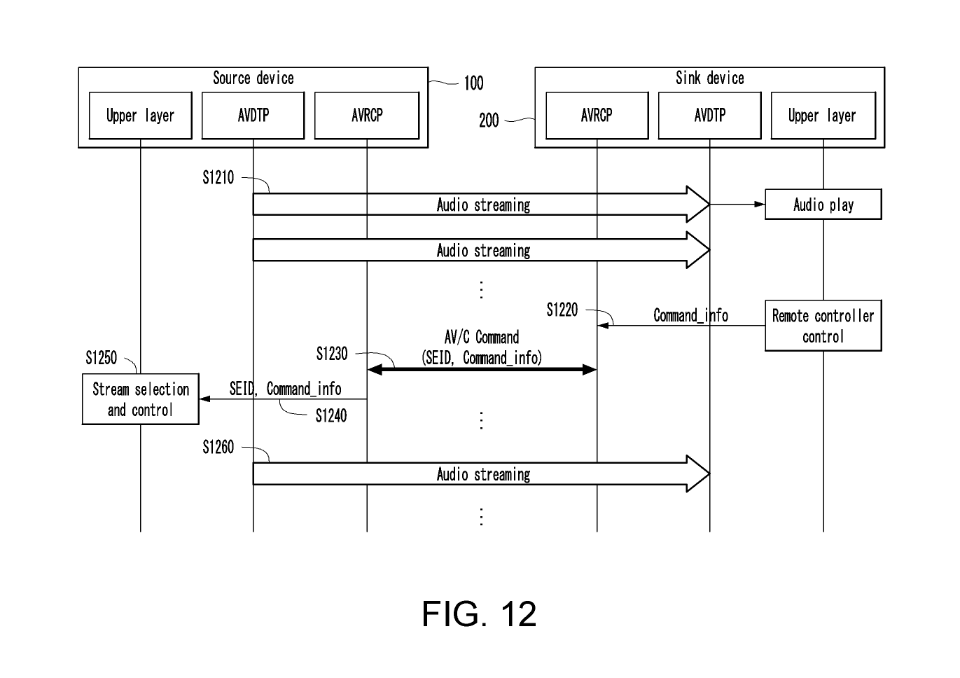

In what follows, described with reference to FIGS. 12 to 15 will be a method for transmitting an SEID through an AV/C command header or performing remote control of multi-channel audio streaming of the Bluetooth communication by designating an SEP after the SEID discovery procedure is completed.

FIG. 12 is a flow diagram illustrating one example of a method for performing remote control of multi-channel audio streaming through an AV/C command including an SEID according to the present invention.

FIG. 12 illustrates a method for transmitting an SEID by using a reserved bit within the AV/C command header of the Bluetooth AVRCP.

As shown in FIG. 12, the sink device receives audio streaming from a source device through the AVDTP S1210.

Next, the sink device performs the AVRCP connection establishment procedure with the source device and obtains SEID list information about SEPs of the source device through the SEP discovery procedure.

Next, in case control of a remote controller occurs in the upper layer of the sink device, the upper layer of the sink device transmits command information related to the control of a remote controller to the AVRCP of the sink device S1220.

Next, to perform remote control, the AVRCP of the sink device transmits the SEID related to the control of a remote controller and the AV/C command including information of the S1220 step to the AVRCP of the source device S1230.

The SEID related to the control of a remote controller can be included in all of the AV/C commands of the AVRCP and in the AV/C specific command header.

Table 1 illustrates one example of the AV/C specific command header format including the SEID according to the present invention.

TABLE 1

| | | | | | | | | |
|---|---|---|---|---|---|---|---|---|
| Oct | MSB (7) | 6 | 5 | 4 | 3 | 2 | 1 | LSB (0) |

| | | |
|---|---|---|
| 0 | 0x0 | Ctype |

| | | |
|---|---|---|
| 1 | Subunit type | Subunit |

| 2 | Opcode | |
|---|---|---|
| 3-5 | Company ID | |
| 6 | PDU_ID | |
| 7 | Stream End Point Identifier (SEID) | Packet Type |

| | |
|---|---|
| 8-9 | Parameter Length |
| 10-n | Parameter |

In table 1, Ctype parameter represents type of the AV/C command, Subunit type parameter represents type of the Subunit, Opcode parameter represents specific operation, Company ID parameter represents a device manufacturer, PDU_ID parameter is used to identify a specific command/response which is a unique identifier with respect to each operation, and Packet Type parameter indicates whether a message is a single packet or multiple packets, where each packet can be start packet, continue packet, or end packet.

Parameter Length is a parameter representing length of a parameter.

Next, the AVRCP of the source device transmits information received from the S1230 step to the upper layer of the source device S1240, and the upper layer of the source device performs control by selecting a stream related to the SEID S1250.

Next, the AVDTP of the source device provides audio streaming to the AVDTP of the sink device according to the S1250 step, S1260.

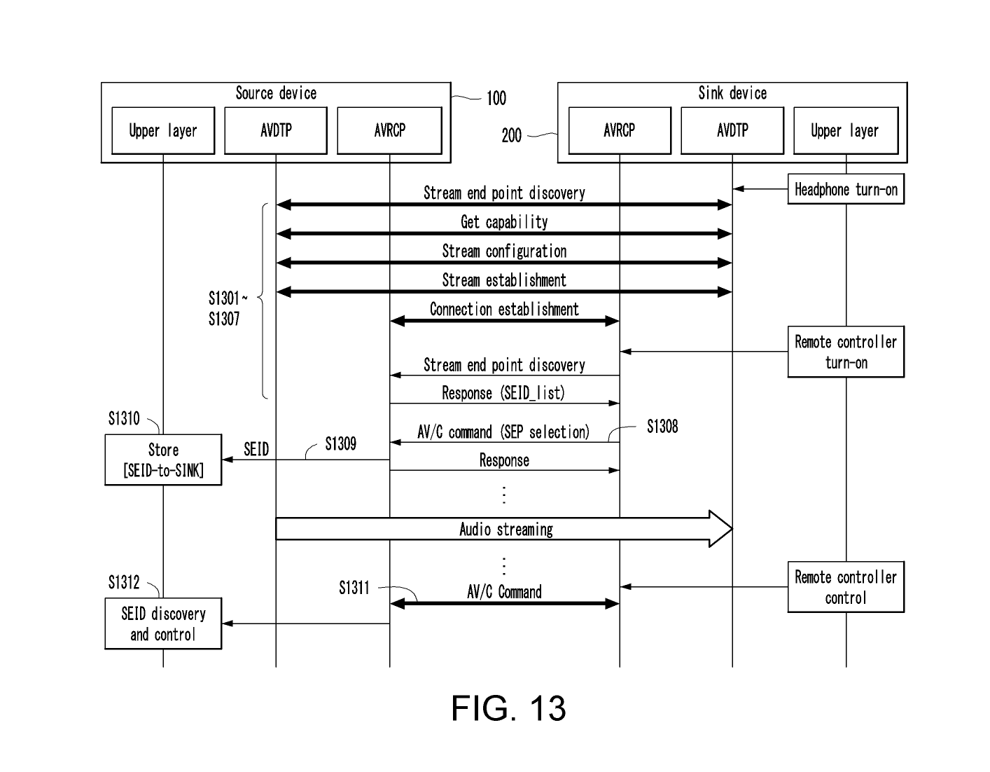

FIG. 13 is a flow diagram illustrating another example of a method for performing remote control of multi-channel audio streaming by designating an SEP within an AV/C command according to the present invention.

Since S1301 to S1307 steps are the same as the S1101 to S1107 steps of FIG. 11, detailed descriptions thereof will be omitted.

After the S1307 step, the AVRCP of the sink device transmits an AV/C command representing SEP selection for designating an SEP related to remote control to the AVRCP of the source device S1308.

The information representing the SEP selection can be transmitted through PDU_ID within the AV/C specific command header.

Table 2 illustrates one example of the AV/C specific command header including information indicating SEP selection according to the present invention.

TABLE 2

| | | | | | | | | |
|---|---|---|---|---|---|---|---|---|
| Oct | MSB (7) | 6 | 5 | 4 | 3 | 2 | 1 | LSB (0) |

| | | |
|---|---|---|
| 0 | 0x0 | Ctype |

| | | |
|---|---|---|
| 1 | Subunit type | Subunit |

| 2 | Opcode | |
|---|---|---|
| 3-5 | Company ID | |
| 6 | PDU ID | |
| 7 | Reserved | Packet Type |

| 8-9 | Parameter Length: 1 | |
|---|---|---|
| 10 | Reserved | SEID |

| | |
|---|---|
| 11-n | Parameter |

In Table 2, if PDU_ID is set to ‘0x19’, the AV/C command indicates selection of a Stream End Point (SEP).

In this case, Parameter Length can be 1, and the SEID can be set by bits ranging from LSB(0) to the bit 5 of the octet corresponding to the field 10.

Next, the AVRCP of the source device transmits the SEID corresponding to the SEP included in the AV/C command to the upper layer of the source device S1309.

At this time, the upper layer of the source device stores the SEID received from the AVRCP of the source device and the sink device corresponding to the SEID in an SEID-SINK matching table S1310.

Next, if the AVRCP of sink device receives an AV/C command related to control of a remote controller while the source device is providing audio streaming to the sink device S1311, the upper layer of the source device searches for the SEID which matches the sink device and performs control of the matched sink device S1312.

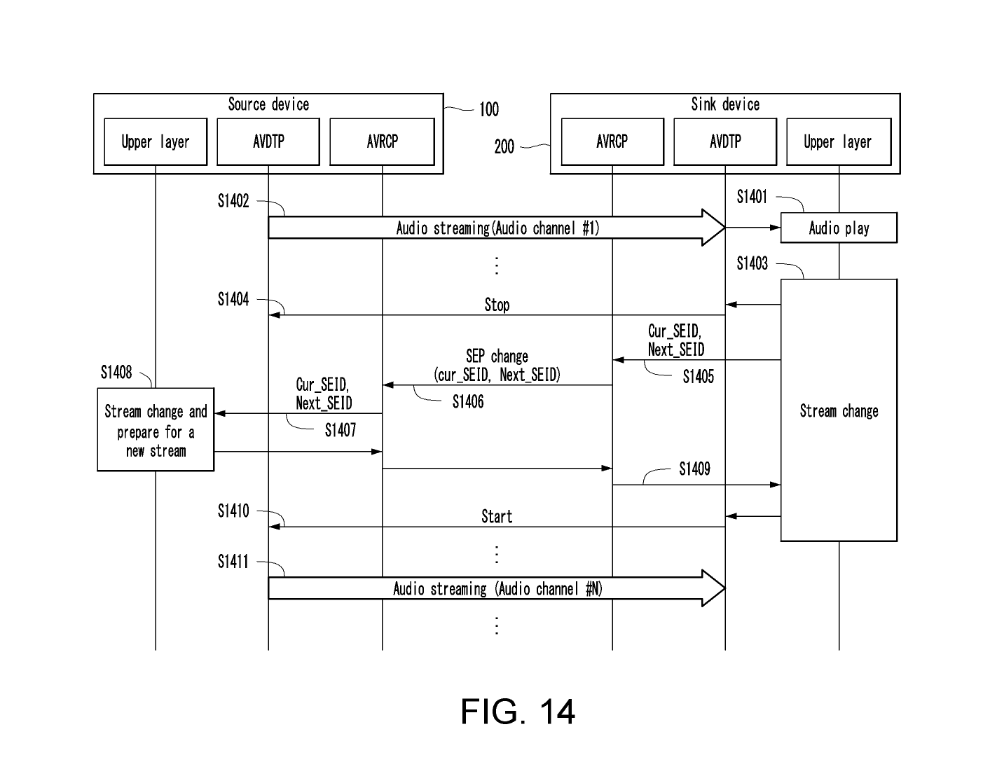

FIG. 14 is a flow diagram illustrating one example of a method for changing an SEP in the AVRCP of Bluetooth communication according to the present invention.

First, in case the upper layer of the sink device performs an audio play function S1401, the sink device receives audio streaming from the source device through audio channel #1 S1402.

Next, in case a current stream being played is changed in the upper layer of the sink device S1403, the AVDTP of the sink device transmits a command which pauses the current stream to the AVDTP of the source device S1404.

The S1404 step is performed depending on the needs, and therefore, streaming may not be stopped even if the current stream being played is changed.

Next, the upper layer of the sink device transmits a current SEID related to a current stream being played and the next SEID related to a stream to be changed to the AVRCP of the sink device S1405.

Next, the AVRCP of the sink device transmits an AV/C command including information indicating change of the SEP to the AVRCP of the source device S1406. At this time, the AV/C command includes information from the S1405 step.

The information indicating change of the SEP can be transmitted by using the PDU_ID of the AV/C specific command header.

Table 3 illustrates one example of an AV/C specific command header format including information indicating change of an SEP according to the present invention.

TABLE 3

| | | | | | | | | |
|---|---|---|---|---|---|---|---|---|
| Oct | MSB (7) | 6 | 5 | 4 | 3 | 2 | 1 | LSB (0) |

| | | |
|---|---|---|
| 0 | 0x0 | Ctype |

| | | |
|---|---|---|
| 1 | Subunit type | Subunit |

| 2 | Opcode | |
|---|---|---|
| 3-5 | Company ID | |
| 6 | PDU ID | |
| 7 | Reserved | Packet Type |

| 8-9 | Parameter Length: 2 | |
|---|---|---|
| 10 | Reserved | Cur SEID |
| 11 | Reserved | Next SEID |

| | |
|---|---|
| 12-n | Parameter |

In Table 3, if PDU_ID is set to ‘0x20’, the AV/C command indicates change of a Stream End Point (SEP).

In this case, Parameter Length is 2, the bits ranging from LSB(0) to the bit 5 of the octet of Parameter 10 are set to Cur SEID, and the bits ranging from LSB(0) to the bit 5 of the octet of Parameter 11 are set to Next SEID.

Next, the AVRCP of the source device transmits the information from the S1405 step to the upper layer of the source device S1407, and the upper layer of the source device changes a current stream and prepares for a new stream to be changed S1408.

The stream change and the new stream in the S1408 step are transmitted in the order of the upper layer of the source device, AVRCP of the source device, AVRCP of the sink device, and the upper layer of the sink device S1409.

Next, the sink device transmits start of a new stream to the source device S1410. The S1410 step may or may not be performed depending on the needs.

Next, the AVDTP of the source device provides audio streaming through a new stream, namely through a different audio channel (for example, #N) to the AVDTP of the sink device S1411.

An output unit capable of displaying a UI on the sink device is needed for a sink device to designate a specific SEID by using the methods of FIGS. 13 and 14.

However, in the case of a sink device which is not equipped with a UI, such as a lightweight headset, it is not easy to designate a specific SEID through the methods of FIGS. 13 and 14.

Therefore, in the case of a sink device not equipped with an output unit through which a UI can be displayed, a specific SEID may not be designated, but an audio stream can be transmitted by transmitting only the FF or REW information to a source device through a hardware device (or constituting element) prepared separately for remote control of an audio stream and changing the SEID sequentially in the source device.

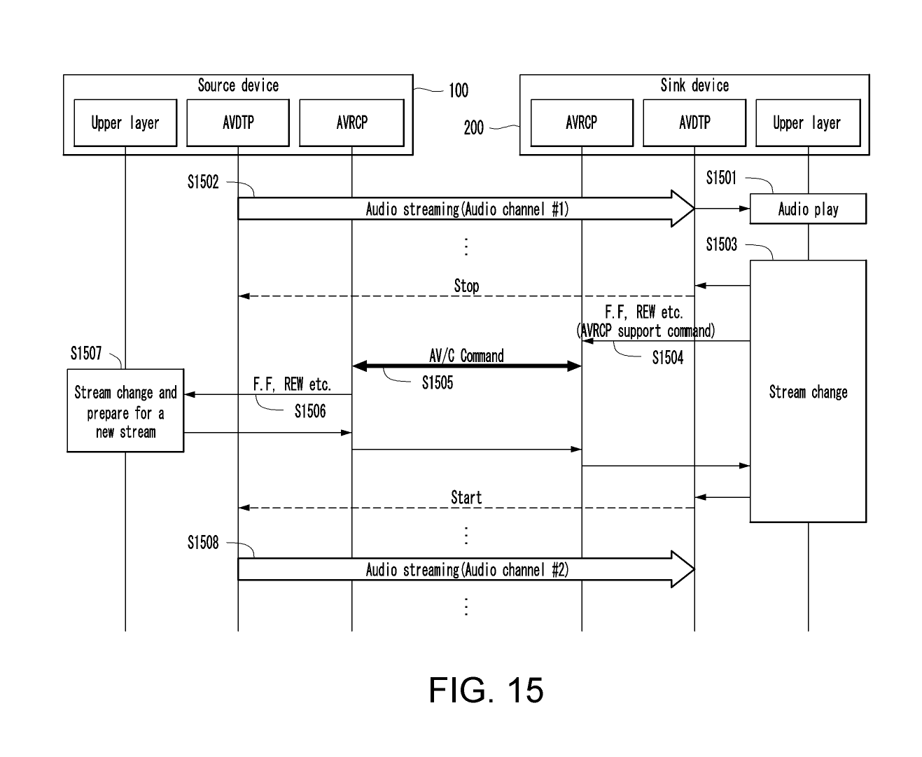

FIG. 15 is a flow diagram illustrating one example of a method for changing an SEP in a sink device which does not provide a User Interface (UI) according to the present invention.

Since the S1501 and the S1502 step are the same as the S1401 and the S1402 step of FIG. 14, only the different part will be described while specific descriptions are omitted.

After the S1502 step, if remote control occurs in the upper layer of the sink device with respect to audio stream change S1503, the AVRCP support command indicating movement to the next audio stream (FF) or movement to the previous stream (REW) is transmitted to the AVRCP of the sink device from the upper layer of the sink device S1504.

Next, the AVRCP of the sink device transmits an AV/C command including information from the S1504 step to the AVRCP of the source device S1505. The AV/C command does not include SEID corresponding to an audio stream.

Next, the AVRCP of the source device transmits information from the S1505 step to the upper layer of the source device S1506; and the upper layer of the source device changes to an audio stream according to the information received from the AVRCP of the source device and prepares for transmission of a new audio stream S1507.

In other words, the upper layer of the source device changes a current audio stream to the next stream or to the previous stream unconditionally according to the information transmitted from the sink device irrespective of a stream channel.

Next, the AVDTP of the source device provides audio streaming to the AVDTP of the sink device through an audio channel #2 different from the previous audio channel (CH #1) S1508.

In the following, described with reference to FIG. 16 will be a method for supporting multi-channel audio streaming by using NFC.

FIG. 16 is a flow diagram illustrating one example of a method for performing multi-channel audio streaming through NFC according to the present invention.

First, a source device and a sink device perform a Stream End Point (SEP) discovery procedure S1601. The S1601 step can be performed through NFC tagging.

In other words, through NFC tagging, the source device can obtain SEID information about the SEPs that the sink device supports, and the sink device can obtain SEID information about the SEPs that the source device supports.

Next, the same steps as the S1020 to the S1050 steps of FIG. 10 are performed, a stream connection is established between the source device and the sink device, and the source device provides audio streaming to the sink device S1602-S1605.

Next, in case a remote control operation is performed in the sink device S1606, the sink device transmits an AV/C command including the SEID related to the remote control to the source device by using the SEID information obtained through the NFC tagging S1607.

Next, the source device selects a stream corresponding to the SEID included in the AV/C command and performs control of the selected stream S1608.

Therefore, through the method of FIG. 16, a source device and a sink device can perform the SEP discovery procedure by simply performing NFC tagging, and since the current AVRCP does not specify a procedure of exchanging SEIDs between a source device and a sink device, the problem of being unable to perform remote control of multi-channel audio streaming can be resolved.

Automatic Connection of Devices by Using NFC and Automatic Continuous Play of A/V Streaming

In what follows, a method for automatic handover of audio streaming to another device by using Near Field Communication (NFC) will be described.

In other words, in case a plurality of source devices attempt to play multimedia contents through one sink device, the present invention provides NFC-based methods: (1) a method for pairing a new source device with a sink device, (2) a method for play control transition among source devices, and (3) a method for automatic successive play of multimedia streaming played in a sourced device.

To this purpose, connected state information, streaming information (Streming ID, Request ID, Device ID, and the like), and a procedure and messages related to an inquiry about whether control transition is allowed and an inquiry result are defined to deal with the case when a new source device is connected to a sink device.

In case multiple users share the same sink device (for example, set-top box (IPTV), TV, sound bar, car-kit speaker, or docking speaker), the user has to put up with inconvenience such that he or she always has to search for a sink device by using the source device and to request a connection to the sink device.

By taking into account the problem above, the present invention provides a method for automatically establishing a connection (or automatically pairing) between a source device and a sink device only through NFC tagging between the source device and the sink device by using an NFC tag (NFC tag is installed inside the sink device) including information of the sink device such as a car-kit or a docking speaker; and a method for automatically playing audio streaming in an automatic manner.

In other words, in case a source device attempts to provide audio streaming through a sink device, the source device can be paired automatically with the sink device by performing tagging (or touching) through an NFC tag installed in the sink device and can automatically play audio streaming through the sink device.

Also, to deal with a situation where a second source device requests audio streaming while a first source device is playing audio streaming through the sink device, the present invention provides a method for releasing audio streaming between the first source device and the sink device.

To this purpose, in the following, described will be (1) a method for transmitting additional information such as SEID and Media Player ID and (2) a method for automatically playing audio streaming by sharing the SEID among devices by utilizing a received SEID at the time of automatic pairing among devices.

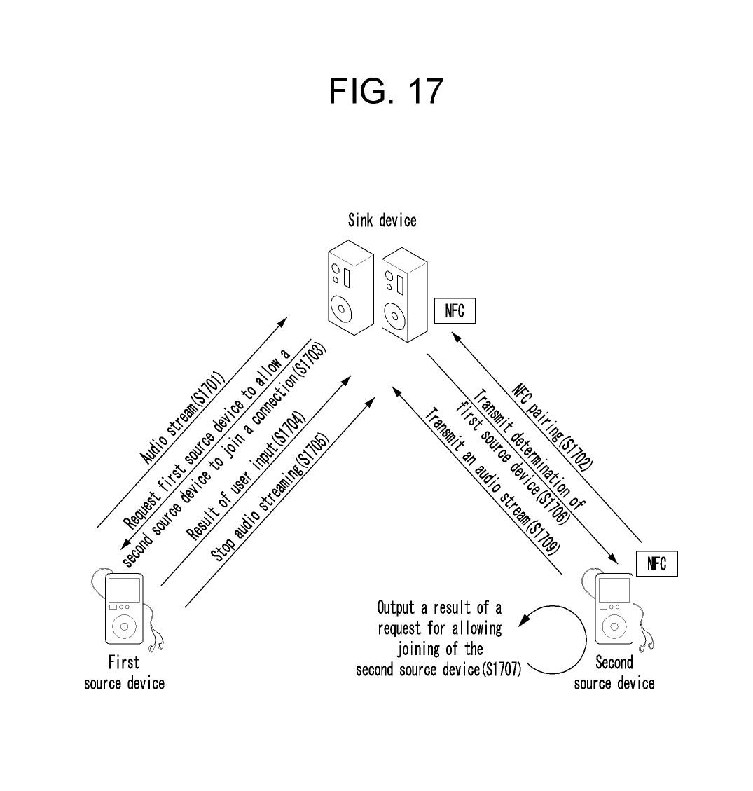

FIG. 17 is a flow diagram illustrating one example of a method for performing automatic connection among devices through NFC and automatic play of audio streaming according to the present invention.

A first source device transmits an audio stream to a sink device to provide audio streaming through the sink device S1701.

Next, a second source device is paired with the sink device through NFC to provide audio streaming of the second source device through the sink device S1702.

At this time, the sink device can determine beforehand the configuration related to whether to enable or disable a connection to a new source device

The configuration can include information (enabled or disabled) indicating whether to perform automatic pairing by using NFC and information (enabled or disabled) indicating a source device's capability of performing handover.

In case the configuration is such that automatic pairing is ‘enabled’ and source device handover is ‘enabled’, the sink device can perform automatic connection to the new source device through NFC and play audio streaming of the new source device.

The sink device exchanges additional information related to audio streaming such as SEID and Media Player ID with the second source device at the time of being paired with the second source device.

Next, in case the second source device is paired with the sink device, the sink device requests the first source device to allow joining of the second source device S1703.

Next, if the first source device receives a request for allowing joining of the second source device from the sink device, the first source device outputs a pop-up message related to the request (approval or denial) to the output unit, and if the first source device receives an approval or denial from the user, the first source device transmits the user input to the sink device S1704.

If the result received from the S1704 step is ‘approval’, audio streaming between the sink device and the first source device is stopped S1705.

Also, the sink device transmits the user input received from the first source device to the second source device S1706.

Next, the second source device checks and outputs the result of a request for allowing joining of the second source device received from the sink device S1707.

Next, if a ‘Play’ control signal is received by the user S1708, the second source device transmits an audio stream to the sink device for audio streaming S1709.

At this time, the sink device can provide audio streaming of the second source device by using the information exchanged in the S1702 step.

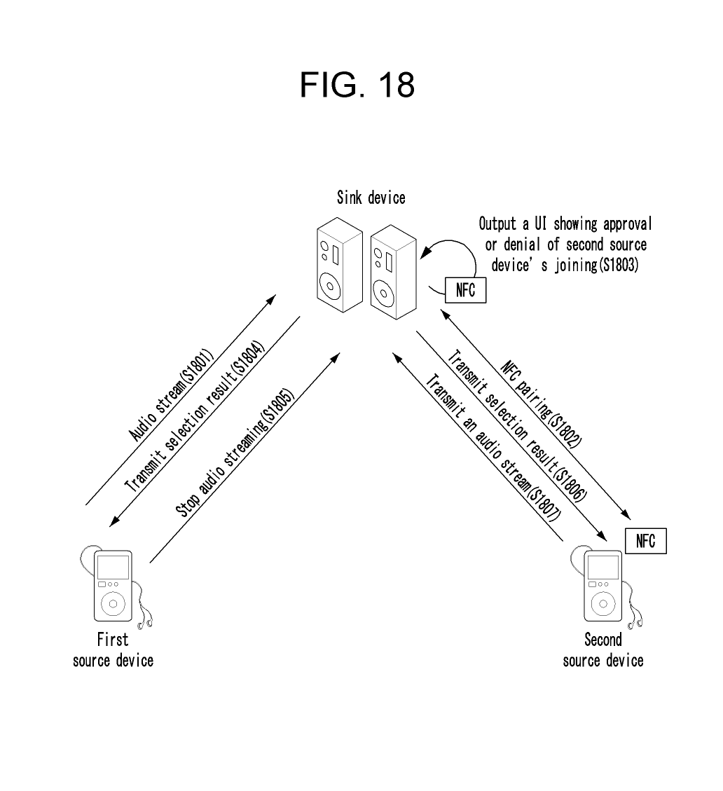

FIG. 18 is a flow diagram illustrating another example of a method for performing automatic connection among devices through NFC tagging and automatic play of audio streaming according to the present invention.

Since the S1801 and the S1802 step are the same as the S1701 and the S1702 step of FIG. 17, only the different part will be described while specific descriptions are omitted.

After the S1802 step, if a sink device and a second source device are paired with each other, the sink device outputs information (approval or denial) indicating whether joining of the second source device is allowed through the output unit of the sink device S1803.

Next, if either ‘approval’ or ‘denial’ displayed through the output unit of the sink device is selected, the sink device transmits the selection result to the first source device S1804.

At this time, if the selected result is ‘approval’, the first source device stops audio streaming being played through the sink device S1805, and if the selected result is ‘denial’, the first source device continues to provide audio streaming through the sink device.

At this time, the sink device also transmits the selected result to the second source device S1806.

At this time, if the selected result is ‘approval’ and the second source device receives a ‘Play’ control signal from the user, the second source device transmits an audio stream to the sink device S1807.

At this time, the sink device provides audio streaming of the second source device by using the information exchanged at the time of being paired with the second source device.

Next, described in detail will be a method for automatic connection to a new device by using NFC, automatic play of A/V streaming, and releasing A/V streaming between devices while A/V streaming is being played through Bluetooth communication.

The Bluetooth standard does not define specific procedures for a method for releasing current A/V streaming between a source device and a sink device for A/V streaming from a different source device to the sink device.

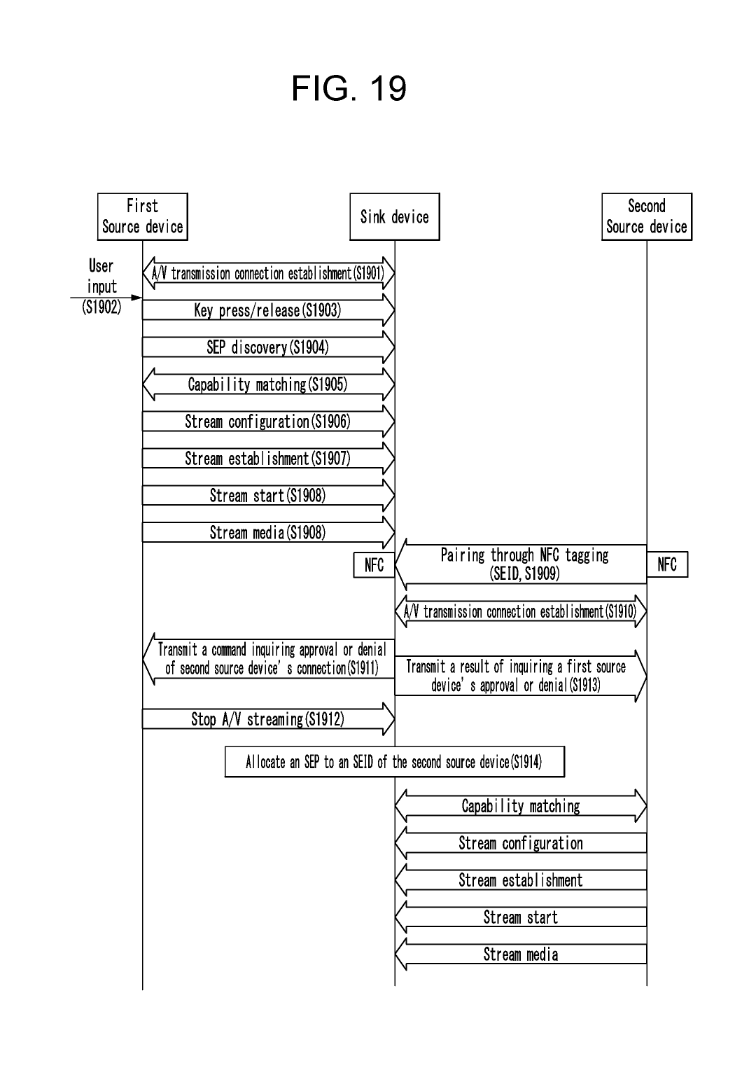

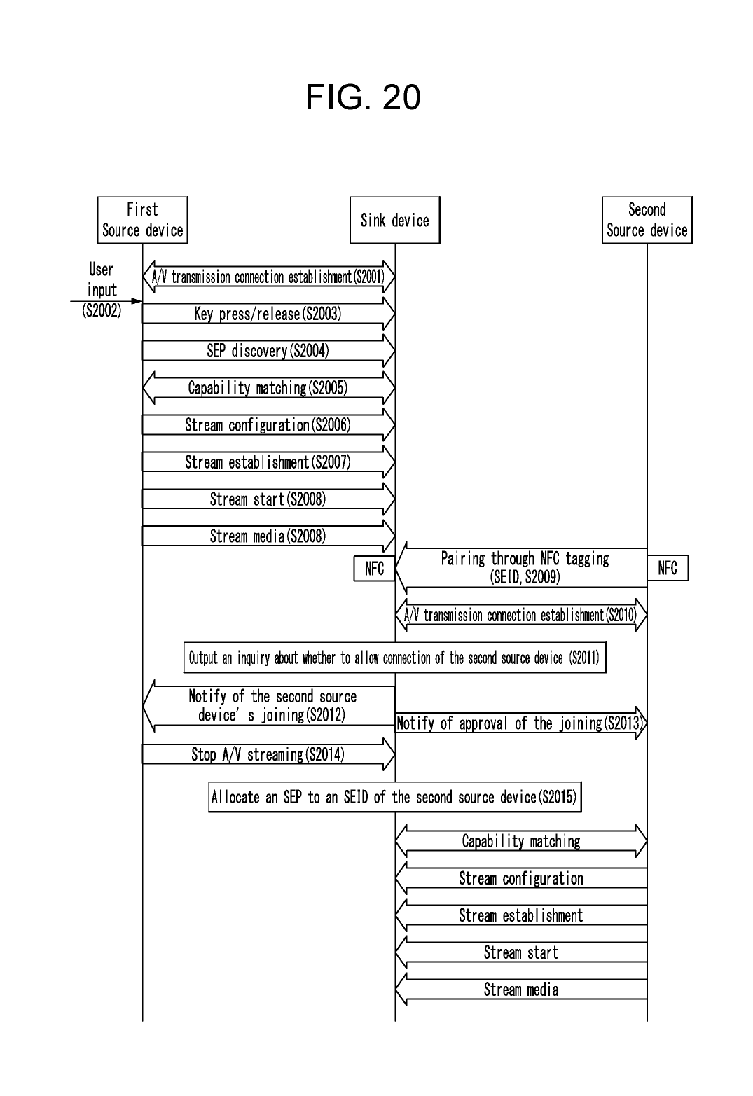

Therefore, with reference to FIGS. 19 and 20, described in detail will be a method for performing automatic connection between a different source device and a sink device by using NFC in the middle of A/V streaming between a current streaming source device and the sink device and a method for releasing A/V streaming between the current streaming source device and the sink device to provide A/V streaming of the different source device through the sink device.

FIG. 19 is a flow diagram illustrating one example of a method for automatic connection among devices through NFC and releasing A/V streaming according to the present invention.

As shown in FIG. 19, the sink device outputs through the output unit automatic pairing-related information by which the user can allow or deny a connection request of a new source device through NFC tagging.

The automatic pairing-related information includes an ‘enabled’ value which allows a connection request for a new source device and a ‘disabled’ value which denies a connection request to the new source device.

Also, through the output unit, the sink device outputs source device handover-related information by which the user can allow or deny a request for automatic continuous play of A/V streaming of a new source device.

The source device handover-related information includes an ‘enabled’ value which allows a request for automatic continuous play of A/V streaming of a new source device and a ‘disabled’ value which denies a request for automatic continuous play of A/V streaming of the new source device.

First, the first source device and the sink device perform an A/V transport connection procedure S1901. Through the A/V transport connection procedure, the first source device and the sink device are paired with each other; and the first source device and the sink device can exchange A/V streams and A/V control commands with each other.

Next, if the first source device receives (from the user) a control signal commanding particular contents to be played through the sink device S1902, the first source device transmits a command with respect to the input control signal to the sink device S1903.

At this time, the control signal may be a motion of the user pressing and releasing a Play button to play music from the first source device.

To describe the S1903 step in more detail, if the first source device receives a user action of pressing the Play key, the first source device transmits a first Pass Through command including Play and Pressed information to the sink device.

And the first source device receives a response to the Pass Through command from the sink device.

Also, if the first source device receives a user action of releasing the Play key, the first source device transmits a second Pass Through command including Play and Released information to the sink device.

And the first source device receives a response to the second Pass Through command from the sink device.

Next, the first source device transmits an SEP discovery message to the sink device to discover an SEP that the sink device supports and to transmit an A/V stream to the sink device S1904; and receives a response to the SEP discovery message from the sink device.

The response includes information (for example, SEID) about the SEP that the sink device supports.

Next, the first source device performs a Capability Matching procedure with the sink device S1905.

Next, the first source device performs a stream configuration procedure with the sink device S1906.

In other words, the first source device reads detailed information about the received SEPs (for example, media type and media codec type) from the sink device and matches the information about the received SEPs to the information about SEPs that the sink device supports.

Also, the first source device transmits the matched information about SEPs and the matched, detailed information about media codec (for example, sampling frequency, channel mode, and sub-band) to the sink device.

To be more specific with the S1906 step, the first source device can transmit detailed information about the media codec to the sink device through the SET_CONFIG_CMD message defined in the AVDTP.

And the first source device receives a SET_CONFIG_RSP message from the sink device in response to the SET_CONFIG_CMD message.

Next, the first source device performs a stream establishment procedure with the sink device S1907.

In other words, the sink device opens a transport channel by using a configured SEP and prepares to receive an A/V stream transmitted from the first source device.

To describe the procedure of opening the transport channel in more detail, the first source device transmits an OPEN_CMD message defined in the AVDTP and receives an OPEN_RSP message from the sink device in response to the OPEN_CMD message.

Also, the first source device transmits a START_CMD message defined in the AVDTP so that the sink device can be prepared to receive an A/V stream through a selected SEP and receives a START_RSP message from the sink device in response to the START_CMD message.

Next, the first source device transmits an A/V stream to the sin device S1908.

While performing the S1908 step, the second source device discovers and selects the sink device to play particular contents through the sink device.

Next, the second source device automatically pairs with the sink device by tagging with an NFC tag of the sink device S1909.

At this time, while pairing through NFC tagging, the second source device transmits an SEID to the sink device so that SEP discovery time for the second source device to discover the SEP that the sink device supports can be reduced or omitted.

The second source device can transmit detailed information such as the SEID and Media Player ID (MPID) to the sink device by including the detailed information in the Bluetooth Out-Of-Band (OOB) data at the S1909 step.

In other words, when performing automatic pairing with the sink device through NFC tagging, the second source device can transmit the SEID and MPID out of the Bluetooth OOB data for transmitting an A/V stream to the sink device by including the SEID and MPID in the AVDTP.

Table 4 and 5 illustrates one example of the Bluetooth OOB data format including the SEID and MPID according to the present invention.

TABLE 4

| Name | Offset | Size | Mandatory/Optional | Description |
|---|---|---|---|---|
| OOB Data | 0 | 2 | M | The total |
| Length | | octets | | length of |
| | | | | OOB data |
| Bluetooth | 2 | 6 | M | Bluetooth |
| Device | | octets | | Device |
| Address | | | | Address of |
| | | | | the device |
| OOB | 8 | N | O | The |
| Optional | | octets | | remaining |
| Data | | | | optional |
| | | | | OOB data, |
| | | | | in EIR(with |
| | | | | SEID) |

Table 5 shows SEID and MPID included in the OOB optional data field of Table 4.

TABLE 5

| Value | Description |
|---|---|
| SEID | Stream End Point |
| | ID(SEID) (6 bit) |
| MPID | Media Player ID(32 bit or |
| | 16 bit) |

Also, the second source device may transmit detailed information such as the SEID and MPID of the S1909 step to the sink device by including the detailed information in the NFC data supporting A/V streaming handover request.

The following XML schema is one example of a format of NFC data which supports A/V streaming handover request, including SEID and MPID transmitted at the time of NFC tagging.

```
<?xml>
< StreamingHandoverRequest >
    < RequestList >
        RequestID
        SEID
        BD_ADDR
        MediaPlayerID
    < StreamingHandoverCondition >
        AutoPairing
        AutoStreamingHanodver
        StreamingStatusNotification
        NetworkConnection
</ StreamingHandoverRequest >
```

### [Example StreamingHandoverRequest via NFC]

```
<?xml version=″1.0″ encoding=″UTF-8″?>
< StreamingHandoverRequest
name=“NFC_StreamingHandoverRequest″>
< RequestList
          RequestID =“002“
          SEID = “012345””
          BD_ADDR = “00:02:72:00:d4:1a”
          MediaPlayerID =“02:01:06:03:02:F0:FF” >
      < StreamingHandoverCondition
          AutoPairing =“true“
          AutoStreamingHanodver =“true”
          StreamingStatusNotification = “true”
            NetworkConnection =“NFC|WLAN|Bluetooth “>
    </ StreamingHandoverRequest >
```

Next, the second source device performs an A/V transport connection establishment procedure with the sink device S1910.

Next, the sink device checks whether the second source device has been connected for A/V streaming and transmits to the first source device a command (notification) inquiring (approval or denial) whether the second source device is allowed to be connected to the sink device S1911.

To describe the S1911 step in more detail, the sink device transmits an AVDTP_NEWSRC_CMD message related to allowing the second source device to play music to the first source device.

The first source device which has received the AVDTP_NEWSRC_CMD message outputs information (approval or denial) through the output unit, by which the user can determine whether to allow connection.

Next, the first source device receives an AVDTP_NEWSRC_RSP message from the sink device in response to the AVDTP_NEWSRC_CMD message.

In case the first source device allows connection to the second source device, the first source device transmits a command stopping A/V streaming (Stream Stop) to the sink device S1912.

To describe the S1912 step in more detail, if the sink device or the first source device allows A/V streaming handover of the second source device, the first source device transmits an AVDTP_CLOSE_CMD message to the sink device to stop A/V streaming and receives an AVDTP_CLOSE_RSP message in response to the AVDTP_CLOSE_CMD message.

Also, determining that it has received the AVDTP_CLOSE_RSP message from the first source device, the sink device terminates an AVDTP connection to the first source device.

Next, the sink device transmits a result with respect to allowing connection of the first source device to the second source device S1913.

To be more specific with the S1913 step, the sink device transmits an AVDTP_JOIN_CMD message to the second source device to transmit the contents of the AVDTP_NEWSRC_RSP message to the second source device and receives an AVDTP_JOIN_RSP message in response to the AVDTP_JOIN_CMD message.

Also, the second source device outputs the contents (approval or denial) of the AVDTP_JOIN_CMD message received from the sink device through the output unit so that the user can see the contents of the AVDTP_JOIN_CMD message through a UI.

Next, the sink device allocates an SEP received from the S1909 step for transmitting A/V streaming to the second source device as the SEID of the second source device S1914.

Next, the second source device and the sink device perform the same procedure as in the S1905 to S1908 steps, and the second source device performs A/V streaming through the sink device.

FIG. 20 is a flow diagram illustrating another example of a method for automatic connection among devices through NFC and releasing A/V streaming according to the present invention.

Since the S2001 to S2010, S2014, and S2015 step are the same as the S1901 to S1910, S1912, and S1914 step of FIG. 19, only the different part will be described while specific descriptions are omitted.

After the S2010 step, the sink device confirms that the second source device has been connected for A/V streaming and outputs information (approval or denial) inquiring whether the second source device is allowed to be connected to the sink device through the output unit so that the user can determine whether to allow the second source device to play A/V streaming S2011.

If the sink device receives a user input indicating allowing the second source device to be connected to the sink device, the sink device transmits to the first source device a command (allowing a new source device to join a connection) indicating that the second source device plays an A/V stream through the sink device S2012.

Also, the sink device transmits to the second source device a command notifying of approval of playing an A/V stream through the sink device S2013.

Next, the second source device and the sink device perform the same procedure as in the S2005 to S2008 step, and the second source device performs A/V streaming through the sink device.

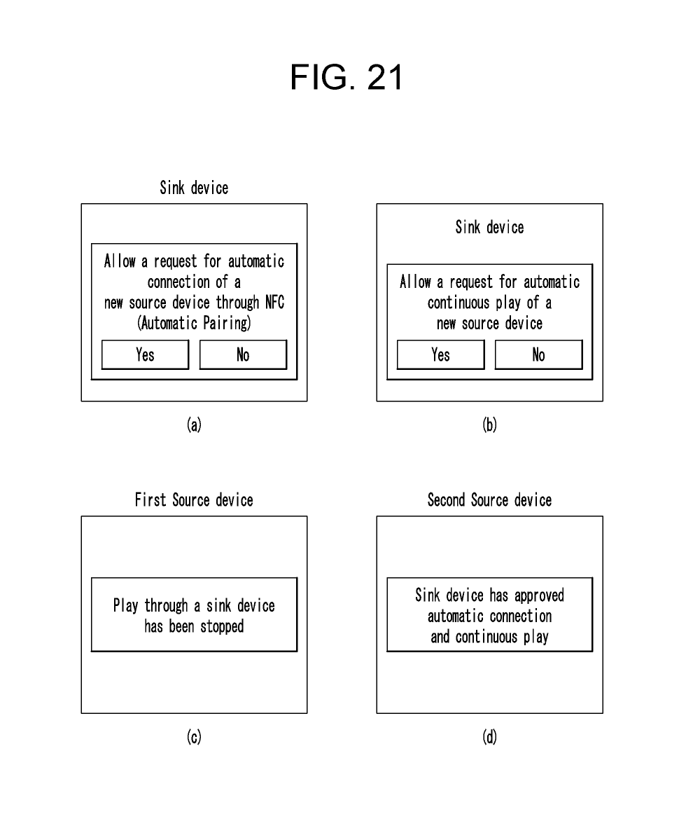

FIG. 21 illustrates one example of an output displayed on a source device and a sink device described in FIGS. 19 and 20.

FIG. 21(a) illustrates a UI displaying automatic pairing-related information through the output unit of the sink device, FIG. 21(b) illustrates a UI displaying source device handover-related information through the output unit of the sink device, FIG. 21(c) illustrates a UI displaying through the output unit of the first source device that A/V streaming of the first source device has been stopped, and FIG. 21(d) illustrates a UI displaying that the second source device is allowed to automatically connected to the sink device and to automatically play A/V streaming continuously through the sink device.

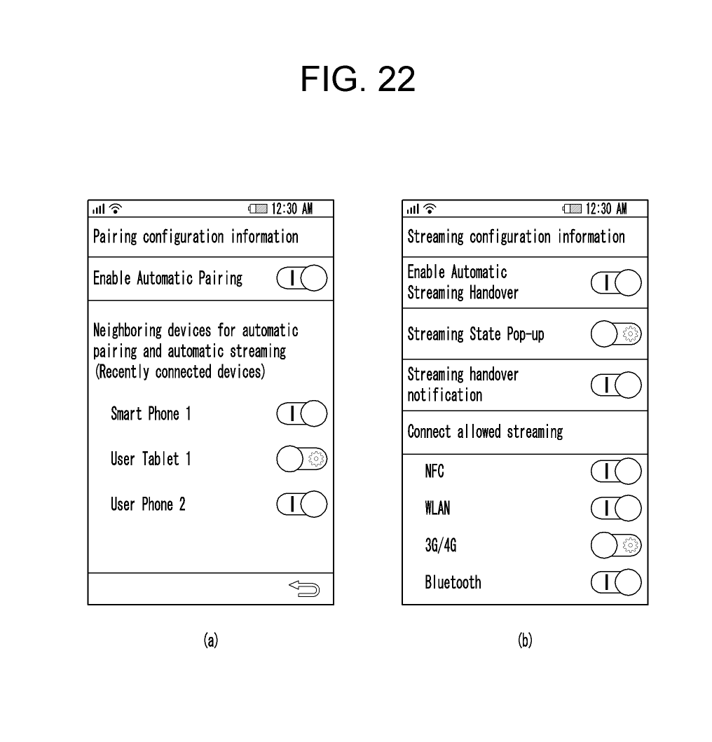

FIG. 22 illustrates one example of a UI implemented in a sink device for automatic connection through NFC and automatic continuous play of A/V streaming according to the present invention.

As shown in FIG. 22(a), Enable Auto Pairing configuration can be displayed on the screen of a sink device, which enables the user to determine whether to enable or disable an automatic connection request of a new source device.

Also, on the screen of the sink device, a list of neighboring devices which allow automatic pairing and automatic continuous play of A/V streaming can be displayed.

FIG. 22(a) shows a list of devices found in the vicinity of the sink device, Smart Phone 1, User Tablet 1, and User Phone 2, among those devices recently connected to the sink device; for the case of Smart phone 1 and User Phone 2, automatic pairing and automatic continuous play of A/V streaming are enabled.

FIG. 22(b) shows a UI (Enable Auto Streaming Handover) which enables the user to determine whether to enable or disable a request of a new source device for automatic continuous play of A/V streaming.

Besides, as shown in FIG. 22(b), the screen of the sink device can display types of networks which allow A/V streaming connection, streaming handover notification, and so on.

Automatic Connection Among Devices and Automatic Continuous Play of A/V Streaming Based on Wi-Fi Direct Communication

In what follows, described will be a method for automatic pairing among devices and automatic continuous play of A/V streaming by using Wi-Fi Direct communication.

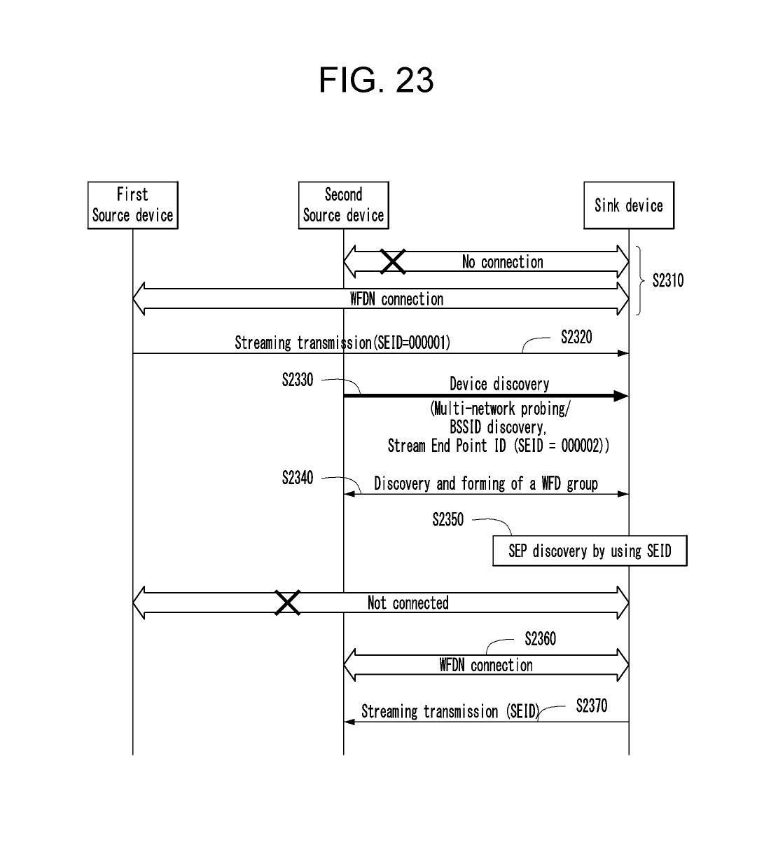

FIG. 23 is a flow diagram illustrating one example of a method for automatic connection and automatic continuous play of A/V streaming through Wi-Fi Direct.

As shown in FIG. 23, a sink device is connected to a first source device through a Wi-Fi Direct Network (WFDN) but is not connected to a second source device yet S2310.

The sink device receives an A/V stream from the first source device through the WFDN S2320.

Through the S2320 step, the first source device transmits A/V streaming to the sink device through the WFDN. The SEID of the A/V stream that the first source device transmits can be set to, for example, ‘000001’.

Next, the second source device performs a device discovery procedure with the sink device by using Wi-Fi Direct communication S2330.

The S2330 step can include procedures such as Multi-Network Probing, Discovery BSSID, and transmission of Stream End Point ID (for example, SEID=000002).

Next, the second source device joins a WFD (Wi-Fi Direct) group by performing procedures of the device discovery and WFD group forming with the sink device S2340.

Next, the sink device discovers an SEP by using the SEID to perform the A/V stream re-connection procedure more quickly afterwards with the second source device S2350.

Next, after the second source device joins the WFD group, the second source device is connected to the sink device through the WFDN S2360.

Next, the second source device transmits an A/V stream to the sink device through the SEID transmitted from the S2330 step, S2370.

The XML schema below shows one example where a Stream End Point ID (SEID) is transmitted during the device discovery procedure (Probing, Discovery Message).

```
<?xml>
      <StreamingHandoverRequest>
            <BSSID>802.11 Wi-Fi Direct BSSID</BSSID> //
      Mandatory
        <P2PGroupID>802.11 Wi-Fi Direct GroupID</P2PGroupID>
      // Mandatory
        <DeviceID> Device Unique ID</DeviceID> // Optional
      <RequestID> Number of Request</RequestID> // Optional
            <SEID>Stream End Point ID</SEID> // Optional
            < MediaPlayerID > Media Player ID </
      MediaPlayerID> // Optional
        <SecurityType>WEP</SecurityType> // Optional
        <SecurityKey>WEPKey</SecurityKey> // Optional
```

### [Example StreamingHandoverRequest via Wi-Fi Direct]

```
<?xml version=″1.0″ encoding=″UTF-8″?>
< StreamingHandoverRequest name=“Wi-
Fi_StreamingHandoverRequest″>
< StreamingHandoverRequest
            BSSID = “WFDBSS”
            P2PGroupID = “WFDP2P”
            DeviceID = “00:02:72:00:d4:1a”
            RequestID =“002“
            SEID = “012345”
            MediaPlayerID =“02:01:06:03:02:F0:FF” >
        < StreamingHandoverCondition
            AutoPairing =“true“
            AutoStreamingHanodver =“true”
            StreamingStatusNotification = “true”
            NetworkConnection =“NFC|WLAN|Bluetooth “>
</ StreamingHandoverRequest >
```

The streaming handover request can include DDI such as Device Information (device/interface address), Device type, friendly name, manufacturer, model description, model name, UDN (UUID), and service list.

In this document, for the convenience of description, the present invention has been described according to the respective drawings; however, it is equally possible to design a new embodiment by merging the embodiments described in the respective drawings. Also, depending on the needs of those skilled in the art, designing a computer-readable recording medium in a computer storing a program for running the embodiments previously described also belongs to the technical scope of the present invention.

A method for providing a wireless docking service according to the present invention is not limited to the embodiments described above, but the entire embodiments can be combined or part of the embodiments can be combined selectively so that various modifications can be made to the embodiments.

Meanwhile, a method for providing a wireless docking service according to the present invention can be implemented in the form of processor-readable program codes in a recording medium that can be read by a processor installed in a network device. The processor readable recording medium includes all kinds of recording devices storing data that can be read by the processor. Examples of processor-readable recording media include ROM, RAM, CD-ROM, magnetic tape, floppy disk, optical data storage device, and implementation in the form of carrier waves such as transmission through the Internet. Also, the processor-readable recording medium can be distributed across computer systems connected to each other through a network, and program codes that can be read by the processor can be stored and run in a distributed manner.

Throughout the document, preferred embodiments of the present invention have been described with referenced to appended drawings; however, the present invention is not limited to the embodiments above. Rather, it should be noted that various modifications of the present invention is made by those skilled in the art to which the present invention belongs without leaving the technical scope of the present invention defined by the appended claims, and these modifications should not be understood individually from the technical principles or aspects of the present invention.

This document describes both of the product invention and process invention, and depending on the needs, descriptions of both inventions can be applied in a complementary manner.

### INDUSTRIAL APPLICABILITY

The present invention provides a method for performing audio/video streaming in a wireless communication system, particularly, in a WPAN (Wireless Personal Area Network).

1. A method for performing Audio/Video (A/V) streaming between at least one source device and at least one sink device in a wireless communication system, the method performed by a source device comprising:
performing a device discovery with a sink device;
receiving from the sink device an A/V source discovery message for discovering information related to A/V channels that the source device supports;
transmitting a response with respect to the A/V source discovery message to the sink device,
wherein the response includes the information related to A/V channels that the source device supports;
receiving from the sink device information related to A/V channels selected by the sink device for A/V streaming;
performing an A/V stream connection for A/V streaming with the sink device; and
transmitting an A/V stream to the sink device by using information related to A/V channels selected by the sink device,
wherein the A/V channel related information includes at least one from among at least one group identification information and at least one stream identification information within each group.

2. The method of claim 1, wherein the A/V channel related information is an identifier (ID) representing at least one of A/V channel and A/V stream.

3. The method of claim 2, wherein the response further comprises a list of available A/V channels.

4. The method of claim 1, wherein the A/V channel related information further comprises a Number of Group ID (NumGID) field representing the total number of groups that the source device supports and a Number of Stream ID (NumSID) field representing the total number of streams that each group provides.

5. The method of claim 1, further comprising:
receiving remote control including A/V channel related information related to control of A/V streaming from the sink device;
performing control of an A/V stream transmitted to the sink device according to the received remote control; and
transmitting a control result of the A/V stream to the sink device.

6. The method of claim 5, wherein the control of the A/V stream is movement to the next A/V stream or to the previous A/V stream.

7. The method of claim 1, wherein reception of the A/V source discovery message and transmission of the response are performed through NFC tagging with the sink device.

8. The method of claim 5, wherein the A/V channel related information is a Stream End Point Identifier (SEID).

9. The method of claim 8, further comprising performing a Stream End Point (SEP) discovery procedure for performing remote control on the sink device, wherein the SEP discovery procedure comprises
receiving from the sink device an SEP discovery message for discovering an SEP that the source device supports; and
transmitting to the sink device a response with respect to the SEP discovery message,
wherein the response includes an SEID list of the source device.

10. The method of claim 9, wherein the remote control is an A/V command message or an A/V command header.

11. The method of claim 10, wherein the A/V command message further comprises at least one of information indicating selection of an SEP and information indicating change of the SEP.

12. A method for performing Audio/Video (A/V) streaming between at least one source device and at least one sink device in a wireless communication system, the method performed by a sink device comprising:
performing a device discovery with a source device;
transmitting to the source device an A/V source discovery message for discovering information related to A/V channels that the source device supports;
transmitting to the selected source device an audio source discovery message to discover an audio source that the selected source device supports;
receiving a response with respect to the A/V source discovery from the source device,
wherein the response includes information related to A/V channels that the source device supports;
selecting A/V channel related information for A/V streaming on the basis of the received response;
transmitting the selected A/V channel related information to the source device; and
receiving an A/V stream from the source device by using the selected A/V channel related information,
wherein the A/V channel related information includes at least one from among at least one group identification information and at least one stream identification information within each group.

13. The method of claim 12, wherein the A/V channel related information is a Stream End Point Identifier (SEID).

14. The method of claim 12, wherein reception of the A/V source discovery message and transmission of the response are performed through NFC tagging with the sink device.

15. The method of claim 13, wherein the source device is a first source device and performs a method comprising
pairing NFC tagging with the second source device;
receiving SEID of the second source device through pairing;
transmitting to the first source device a request for the second device to join A/V streaming;
receiving a result with respect to the request from the first source device; and
receiving an A/V stream from the second source device on the basis of SEID of the second source device received through the pairing if the received result indicates that the second source device is allowed to join A/V streaming.

16. The method of claim 14, further comprising stopping A/V streaming to the sink device.

17. The method of claim 14, wherein the SEID of the second source device is included in the Out-Of-Band (OOB) data of Bluetooth.

18. The method of claim 12, wherein the OOB data further comprises Media Player ID (MPID).

19. The method of claim 13, wherein the source device is a first source device and performs a method further comprising
receiving an A/V stream from the first source device through Wi-Fi Direct communication;
performing a device discovery procedure through Wi-Fi Direct communication with a second source device;
receiving SEID of the second source device through the device discovery procedure and forming a Wi-Fi Direct Network (WFDN) group with the second source device; and
receiving an A/V stream from the second source device.

20. In a method for performing Audio/Video (A/V) streaming between at least one source device and at least one sink device in a wireless communication system, the source device comprising:
a communication unit for transmitting and receiving a signal with the outside in a wired and/or wireless manner; and
a controller connected functionally to the communication unit, wherein the controller is configured
to perform a device discovery procedure with a sink device;
to receive from the sink device an A/V source discovery message for discovering information related to A/V channels that the source device supports;
to transmit a response with respect to the A/V source discovery message to the sink device, where the response includes the information related to A/V channels that the source device supports;
to receive from the sink device information related to A/V channels selected by the sink device for A/V streaming;
to perform an A/V stream connection procedure for A/V streaming with the sink device; and
to transmit an A/V stream to the sink device by using information related to A/V channels selected by the sink device,
wherein the A/V channel related information includes at least one from among at least one group identification information and at least one stream identification information within each group.
